(19) United States
(12) Patent Application Publication
(10) Pub. No.: US 2018/0211021 A1
(43) Pub. Date: Jul. 26, 2018

(54) AUTHENTICATION DEVICE, AUTHENTICATION SYSTEM, AND AUTHENTICATION METHOD

(71) Applicant: MITSUBISHI ELECTRIC CORPORATION, Tokyo (JP)

(72) Inventors: Tomonori NEGI, Tokyo (JP); Takeshi YONEDA, Tokyo (JP); Nori MATSUDA, Tokyo (JP); Takumi MORI, Tokyo (JP); Takato HIRANO, Tokyo (JP); Yoshihiro KOSEKI, Tokyo (JP); Kiyoto KAWAUCHI, Tokyo (JP)

(73) Assignee: MITSUBISHI ELECTRIC CORPORATION, Tokyo (JP)

(21) Appl. No.: 15/744,706

(22) PCT Filed: Aug. 6, 2015
(86) PCT No.: PCT/JP2015/072363

§ 371 Date: Jan. 12, 2018

(51) Int. Cl. G06F 21/32; G06F 21/64; H04L 29/06; H04L 9/08; H04L 9/32

(52) U.S. Cl. CPC G06F 21/32; G06F 21/64; H04L 63/0853; H04L 63/0838; G06K 2209/01; H04L 9/085; H04L 9/0894; H04L 9/0869; H04L 9/3247; H04L 63/126

(57) ABSTRACT

The present invention relates to an authentication device that executes an online transaction typified by a transfer process of an online banking service.

The authentication device includes a secret information storage unit to store secret information; a verification unit to verify validity of input data including input information of a user; an information extraction unit to extract the input information from the input data the validity of which has been verified by the verification unit; an authentication information generation unit to generate authentication information with the input information extracted by the information extraction unit and the secret information stored in the secret information storage unit; and a display unit to display the authentication information generated by the authentication information generation unit.

### TECHNICAL FIELD

The present invention relates to an authentication device that executes an online transaction typified by a transfer process of an online banking service.

### BACKGROUND ART

In recent years, fraudulent remittance in online banking caused by a MITM (Man-in-the-Middle) attack has occurred frequently. The MITM attack refers to an attack by which an attacker intervenes between correspondents to eavesdrop on encrypted communication and tamper with communication data, and is also called a man-in-the-middle attack. The most effective measure currently used against fraudulent remittance in online banking caused by a MITM attack is transaction signature using an OCRA-specification OTP token.

The OCRA specification is a specification for challenge-response algorithms in compliance with the OATH (Initiative for Open AuTHentication) standard, and the specific name of the standard is OATH Challenge-Response Algorithms Specification RFC 6287. The OTP refers to a one-time password which is a password used only once. The OTP token refers to a special-purpose security device for generating an OTP. Specifically, the OTP token is a small portable terminal that generates a signature value which is an OTP.

FIG. 56 is a diagram illustrating a flow of transaction signature using an OCRA-specification OTP token.

Referring to FIG. 56, when executing a transfer process, a user 5602 using Internet banking enters transfer information such as a transfer destination account number and a transfer amount into an OCRA-specification OTP token 5601 (5606). The OCRA-specification OTP token 5601 generates a signature for the transfer information (5607), and displays the signature for the user 5602 (5608). Further, on a transfer process screen for Internet banking on a PC 5603, the user 5602 enters the signature generated by the OTP token 5601 together with the transfer information (5609), and the PC 5603 transmits the transfer information and the signature to an Internet banking server 5604 (5610).

The Internet banking server 5604 retrieves an OTP token ID of the user 5602 (5611), and transmits the OTP token ID together with the transmitted transfer information to an OCRA-compliant OTP authentication server 5605 (5612). The OCRA-compliant OTP authentication server 5605 generates a verification signature according to the same method as with the OCRA-specification OTP token 5601 (5613), and transmits the verification signature to the Internet banking server 5604 (5614).

The Internet banking server 5604 verifies the signatures, using the signature transmitted from the user 5602 and the verification signature transmitted from the OCRA-compliant OTP authentication server 5605 (5615). If the values of the signatures match, the Internet banking server 5604 determines that the transfer information is proper and continues with the transfer process. On the other hand, if the values of the signatures do not match, the Internet banking server 5604 determines that the transfer information is fraudulent, and transmits an error message to the PC 5603.

However, the transaction signature using the OCRA-specification OTP token 5601 has two problems. The first problem is that it is necessary for the bank to provide the user with a special-purpose security device which is the OCRA-specification OTP token 560, resulting in increased cost. The second problem is that it is necessary for the user to prepare the special-purpose security device and enter a transfer destination account number and a transfer amount into the special-purpose security device by hand, resulting in undesirable operability.

As an arrangement for solving the above problems, there is a transaction authentication method disclosed in Patent Literature 1, for example.

FIG. 57 is a diagram illustrating a flow of a transaction authentication process of Patent Literature 1.

In the transaction authentication process of FIG. 57, a smartphone 5701 equipped with a camera is used in place of the special-purpose security device, and an Internet banking server 5703 and the smartphone 5701 share secret information and a terminal ID of the smartphone 5701. Then, the smartphone 5701 photographs and thereby reads a two-dimensional code displayed on a transfer process confirmation screen on a client computer 5702 (5713), verifies transfer information and a remittance confirmation code which are embedded in the two-dimensional code (5714), and generates a user confirmation code (5715), thereby guaranteeing the security of the transaction and the credibility of the transaction.

However, the transaction authentication process of Patent Literature 1 does not anticipate that the smartphone 5701 may be infected with malware and the malware may collaborate with malware performing a MITB attack on the client computer 5702. Therefore, if the malware which has infected the smartphone 5701 and the malware performing a MITB attack on the client computer 5702 collaborate with each other, fraudulent remittance in online banking can be performed easily. This is because it is attempted to guarantee the security of the transaction and the credibility of the transaction on the smartphone 5701 which is not at all functionally protected by using only the two-dimensional code which can be easily forged by malware.

Patent Literature 2 discloses a technology in which a portable information terminal photographs, with a camera, transfer information shown in a transfer form or invoice, and the transfer information which has been character-recognized is displayed on the portable information terminal, and then after a user checks the transfer information, a transfer instruction is transmitted to a server of a bank. This technology aims to easily perform a transfer process based on transfer information described on a paper medium, and cannot realize a secure transaction in online banking. Moreover, in this technology, a character recognition process and a transfer instruction are performed on a cellular phone or smartphone which is not at all functionally protected, so that it is possible to conduct fraudulent remittance.

### CITATION LIST

### Patent Literature

Patent Literature 1: JP 2014-106593 A
Patent Literature 2: JP 2008-146347 A

### SUMMARY OF INVENTION

### Technical Problem

With the conventional technology, there is no arrangement to make it difficult for malware to tamper with transfer information, and moreover the cellular phone or smartphone is not at all functionally protected. Therefore, there is a problem that if the cellular phone or smartphone is infected with malware, the security of the transaction and the credibility of the transaction cannot be sufficiently guaranteed.

The present invention has been made to solve the above problems, and aims to securely and reliably execute an online transaction typified by a transfer process in online banking without using a special-purpose security device even if a user terminal such as a cellular phone or smartphone which is used in place of the special-purpose security device is infected with malware.

### Solution to Problem

To solve the above-described problems, an authentication device according to the present invention includes: a secret information storage unit to store secret information; a verification unit to verify validity of input data including input information of a user; an information extraction unit to extract the input information from the input data the validity of which has been verified by the verification unit; an authentication information generation unit to generate authentication information of the user with the input information extracted by the information extraction unit and the secret information stored in the secret information storage unit; and a display unit to display the authentication information generated by the authentication information generation unit.

### BRIEF DESCRIPTION OF DRAWINGS

FIG. 1 is an overall view of a basic system configuration for implementing the present invention;

FIG. 2 is a diagram illustrating a hardware configuration of a smartphone 101 which is an authentication device according to Embodiment 1;

FIG. 3 is a diagram illustrating a hardware configuration of a SIM card 210 according to Embodiment 1;

FIG. 4 is a diagram illustrating a hardware configuration of a host server 103 according to Embodiment 1;

FIG. 5 is a diagram illustrating a hardware configuration of a client computer 102 according to Embodiment 1;

FIG. 6 is a diagram illustrating an example of secret information stored by a secret information holding device 406 on the server side;

FIG. 7 is a diagram illustrating an operational sequence of an online transaction according to Embodiment 1;

FIG. 8 is a flowchart illustrating a flow of the operation of the client computer 102 according to Embodiment 1;

FIG. 9 is a flowchart illustrating a flow of the operation of the host server 103 according to Embodiment 1;

FIG. 10 is a flowchart illustrating a flow of the operation of the smartphone 101 and the SIM card 210 according to Embodiment 1;

FIG. 11 is a diagram illustrating an example of a transfer information registration table 1101 to store transfer information (a transfer destination account number 1103 and a transfer amount 1104) and a random number 1105 which are registered in the host server 103;

FIG. 12 is a diagram illustrating an example of a confirmation screen 1201 for a transfer that the host server 103 transmits to the client computer 102;

FIG. 13 is a diagram illustrating an example of a screen 1301 on which the smartphone 101 displays transfer information (a transfer destination account number 1302 and a transfer amount 1303), a random number 1304, and a signature 1305;

FIG. 14 is a diagram illustrating a hardware configuration of a SIM card 210 according to Embodiment 2;

FIG. 15 is a diagram illustrating an example of a display rule table 1501 to hold a display rule;

FIG. 16 is a diagram illustrating a hardware configuration of a smartphone 101 according to Embodiment 3;

FIG. 17 is a diagram illustrating a hardware configuration of a SIM card 210 according to Embodiment 3;

FIG. 18 is a diagram illustrating an operational sequence of an online transaction according to Embodiment 3;

FIG. 19 is a diagram illustrating a flow of the operation of the smartphone 101 and the SIM card 210 according to Embodiment 3;

FIG. 20 is a diagram illustrating a hardware configuration of a smartphone 101 according to Embodiment 4;

FIG. 21 is a diagram illustrating a hardware configuration of a SIM card 210 according to Embodiment 4;

FIG. 22 is a flowchart illustrating a flow of the operation of the smartphone 101 and the SIM card 210 according to Embodiment 4;

FIG. 23 is a diagram illustrating a hardware configuration of a SIM card 210 according to Embodiment 5;

FIG. 24 is a diagram illustrating a hardware configuration of a SIM card 210 according to Embodiment 6;

FIG. 25 is a diagram illustrating a hardware configuration of a host server 103 according to Embodiment 6;

FIG. 26 is a diagram illustrating an operational sequence of an online transaction according to Embodiment 6;

FIG. 27 is a flowchart illustrating a flow of the operation of a client computer 102 according to Embodiment 6;

FIG. 28 is a flowchart illustrating a flow of the operation of the host server 103 according to Embodiment 6;

FIG. 29 is a flowchart illustrating a flow of the operation of the smartphone 101 and the SIM card 210 according to Embodiment 6;

FIG. 30 is a diagram illustrating an example of a transfer information registration table 3001 to store the transfer information (the transfer destination account number 1103 and the transfer amount 1104) and a one-time password or random number 3002 which are registered in the host server 103;

FIG. 31 is a diagram illustrating a confirmation screen 3101 for a transfer that the host server 103 transmits to the client computer 102;

FIG. 32 is a diagram illustrating an example of a screen 3201 on which the smartphone 101 displays the transfer information (the transfer destination account number 1302 and the transfer amount 1303) and a one-time password or signature 3202;

FIG. 33 is a diagram illustrating a hardware configuration of a SIM card 210 according to Embodiment 7;

FIG. 34 is a diagram illustrating a hardware configuration of a host server 103 according to Embodiment 7;

FIG. 35 is a flowchart illustrating a flow of the operation of the host server 103 according to Embodiment 7;

FIG. 36 is a flowchart illustrating a flow of the operation of the smartphone 101 and the SIM card 210 according to Embodiment 7;

FIG. 37 is a diagram illustrating a hardware configuration of a SIM card 210 according to Embodiment 8;

FIG. 38 is a flowchart illustrating a flow of the operation of the smartphone 101 and the SIM card 210 according to Embodiment 8;

FIG. 39 is a diagram illustrating a hardware configuration of a SIM card 210 according to Embodiment 9;

FIG. 40 is a diagram illustrating a hardware configuration of a SIM card 210 according to Embodiment 10;

FIG. 41 is a diagram illustrating a hardware configuration of a host server 103 according to Embodiment 10;

FIG. 42 is a diagram illustrating an operational sequence of an online transaction according to Embodiment 10;

FIG. 43 is a flowchart illustrating a flow of the operation of the host server 103 according to Embodiment 10;

FIG. 44 is a flowchart illustrating a flow of the operation of the smartphone 101 and the SIM card 210 according to Embodiment 10;

FIG. 45 is a diagram illustrating an example of a confirmation screen 4501 for a transfer that the host server 103 transmits to the client computer 102;

FIG. 46 is a diagram illustrating an example of a character image 4601 in which transfer information of the confirmation screen 4501 is embedded;

FIG. 47 is a diagram illustrating an example of an information embedding rule 4701 shared by the smartphone 101 and the host server 103 of a bank;

FIG. 48 is a diagram illustrating an example of an information embedding rule table 4801;

FIG. 49 is a diagram illustrating a hardware configuration of a SIM card 210 according to Embodiment 11;

FIG. 50 is a diagram illustrating a hardware configuration of a host server 103 according to Embodiment 11;

FIG. 51 is a flowchart illustrating a flow of the operation of the host server 103 according to Embodiment 11;

FIG. 52 is a flowchart illustrating a flow of the operation of the smartphone 101 and the SIM card 210 according to Embodiment 11;

FIG. 53 is a diagram illustrating a hardware configuration of a SIM card 210 according to Embodiment 12;

FIG. 54 is a flowchart illustrating a flow of the operation of a smartphone 101 and the SIM card 210 according to Embodiment 12;

FIG. 55 is a diagram illustrating a hardware configuration of a SIM card 210 according to Embodiment 13;

FIG. 56 is a diagram illustrating a flow of transaction signature using an OCRA-specification OTP token; and

FIG. 57 is a diagram illustrating a flow of a transaction authentication process of Patent Literature 1.

### DESCRIPTION OF EMBODIMENTS

Embodiments of the present invention will be described hereinafter with reference to the drawings, using a transfer procedure in Web online banking as an example of an online transaction. In these embodiments, transfer information such as a transfer destination account number and a transfer amount corresponds to transaction information. These embodiments are for describing preferred embodiments of the present invention, and the present invention is not limited to what is described herein.

Like reference numerals indicate like objects throughout the drawings.

### Embodiment 1

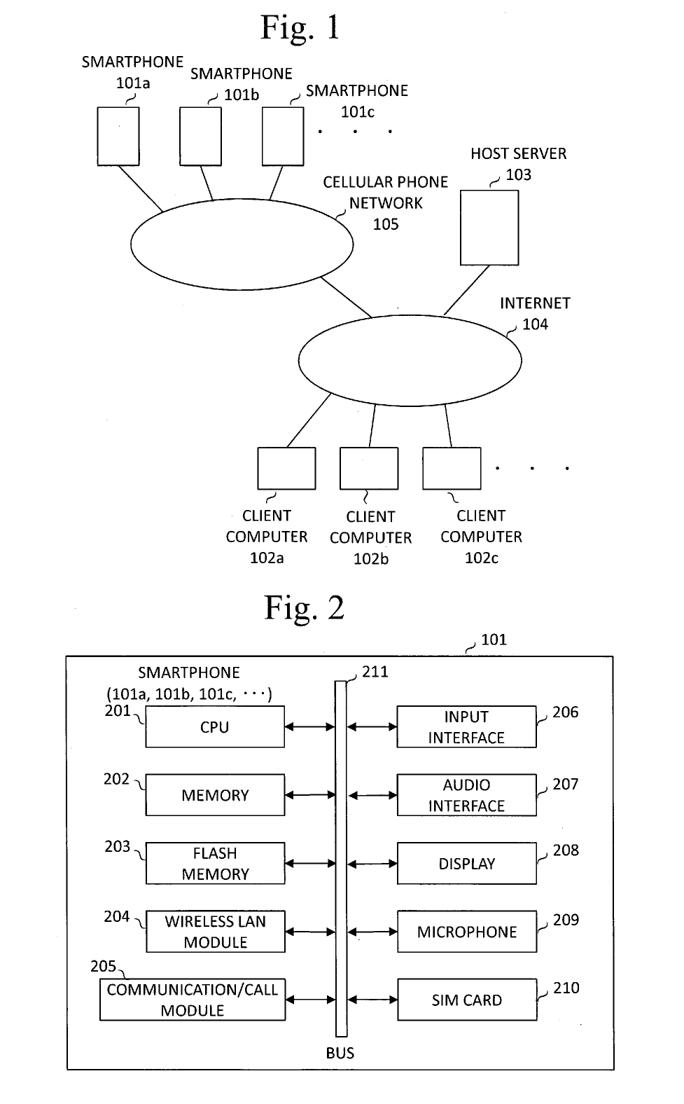

FIG. 1 is an overall view of a basic system configuration for implementing the present invention.

Referring to FIG. 1, a plurality of client computers 102a, 102b, 102c, and so on are connected via Internet 104 to a host server 103 of a bank providing an online banking service. Hereinafter, the plurality of client computers 102a, 102b, 102c, and so on will be collectively referred to as a client computer 102. Each user of the client computer 102 has a corresponding one of smartphones 101a, 101b, 101c, and so on as a user terminal. Hereinafter, the smartphones 101a, 101b, 101c, and so on will be collectively referred to as a smartphone 101. The smartphone 101 is connected to the Internet 104 via a cellular phone network 105. The smartphone 101 is an example of an authentication device.

The user of the client computer 102 accesses the host server 103 via the Internet 104 for the purpose of conducting a transaction by online banking, and logs in to the online banking service with a given user ID and a corresponding password. At this time, communication between the client computer 102 and the host server 103 is guaranteed confidentiality and integrity with a cryptographic communication protocol such as SSL/TLS (Secure Socket Layer/Transport Layer Security).

Embodiment 1 will be described assuming that a feature that can identify a user, that is, user identification information is a voice print, and that an input device that accepts an input including the feature that can identify the user is a microphone. However, the feature that can identify the user may also be handwriting, hand gestures, gestures, and so on, and the voice print and the microphone are non-limiting examples.

FIG. 2 is a diagram illustrating a hardware configuration of the smartphone 101 which is an authentication device according to Embodiment 1.

Referring to FIG. 2, a CPU 201, a memory 202, a flash memory 203, a wireless LAN module 204, a communication/call module 205, an input interface 206 such as a touch panel, and an audio interface 207 are connected to a bus 211. The wireless LAN module 204 and the communication/call module 205 are examples of a communication device.

In addition, a display 208 which is a display device, a microphone 209 which is an input device that accepts an input including the feature that can identify the user, and a SIM card (Subscriber Identity Module Card) 210 which is secure against intrusion by malware are connected to the bus 211 of the smartphone 101. The display 208 is an example of a display unit.

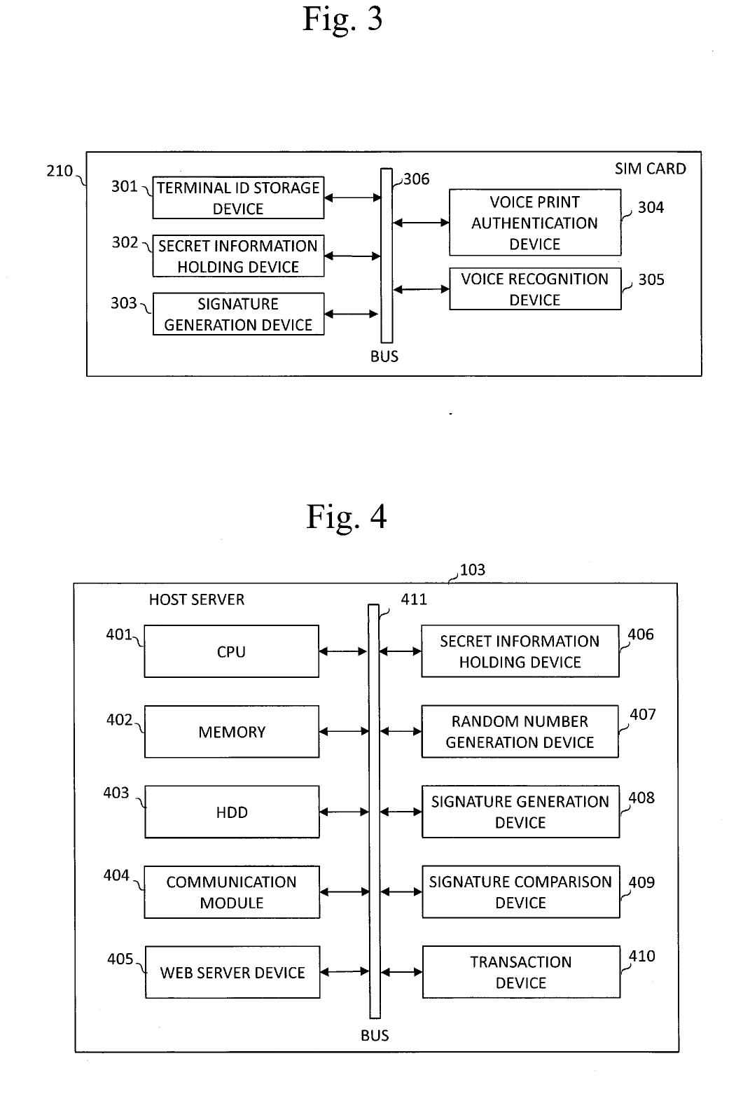

FIG. 3 is a diagram illustrating a hardware configuration of the SIM card 210 according to Embodiment 1.

Referring to FIG. 3, a terminal ID storage device 301 for fulfilling regular functions of the SIM card 210 is connected to a bus 306.

In addition, a secret information holding device 302 on the user-terminal side, a signature generation device 303 on the user-terminal side, a voice print authentication device 304, and a voice recognition device 305 are connected to the bus 306 of the SIM card 210. The secret information holding device 302 on the user-terminal side is a device that holds secret information shared with the host server 103 of the bank. The secret information holding device 302 is an example of a secret information storage unit. The signature generation device 303 on the user-terminal side is a device that calculates a hash value or the like of transfer information to calculate a signature for the transfer information. The signature generation device 303 is an example of an authentication information generation unit and a signature generation unit. The voice print authentication device 304 is a device that authenticates the user, based on a voice print of voice input from the microphone 209 of the smartphone 101. The voice print authentication device 304 is an example of a verification unit. The voice recognition device 305 is a device that recognizes speech content from the voice of the user input from the microphone 209 of the smartphone 101. The voice recognition device 305 is an example of an information extraction unit.

FIG. 4 is a diagram illustrating a hardware configuration of the host server 103 according to Embodiment 1.

Referring to FIG. 4, a CPU 401, a memory 402, a hard disk drive (HDD) 403, and a communication module 404 are connected to a bus 411. The communication module 404 is an example of a server communication unit.

In addition, a Web server device 405 which is an online transaction server, a secret information holding device 406 on the server side, a random number generation device 407, a signature generation device 408 on the server side, a signature comparison device 409, and a transaction device 410 are connected to the bus 411 of the host server 103. The secret information holding device 406 on the server side is an example of a server secret information storage unit. The random number generation device 407 is an example of a random number generation unit. The signature generation device 408 on the server side is an example of a server signature generation unit. The signature comparison device 409 is an example of a comparison device. The Web server device 405 is a device that provides the online banking service to the client computer 102. The secret information holding device 406 on the server side is a device that holds the secret information shared with the smartphone 101. The random number generation device 407 is a device that generates a random number including a random character string. The signature generation device 408 on the server side is a device that calculates a hash value or the like of transfer information to calculate a signature for the transfer information. The signature comparison device 409 is a device that compares the signature transmitted from the client computer 102 with the signature calculated by the signature generation device 408 on the server side and outputs a comparison result. The transaction device 410 is a device that processes a transaction such as a transfer.

The secret information holding device 406 on the server side of the host server 103 stores secret information associated with users.

FIG. 6 is a diagram illustrating an example of the secret information stored by the secret information holding device 406 on the server side.

Referring to FIG. 6, the secret information holding device 406 on the server side holds a secret information management table 601 which stores a user ID 602 (602a, 602b, 603c, and so on) and corresponding secret information 603 (603a, 603b, 603c, and so on) for each user.

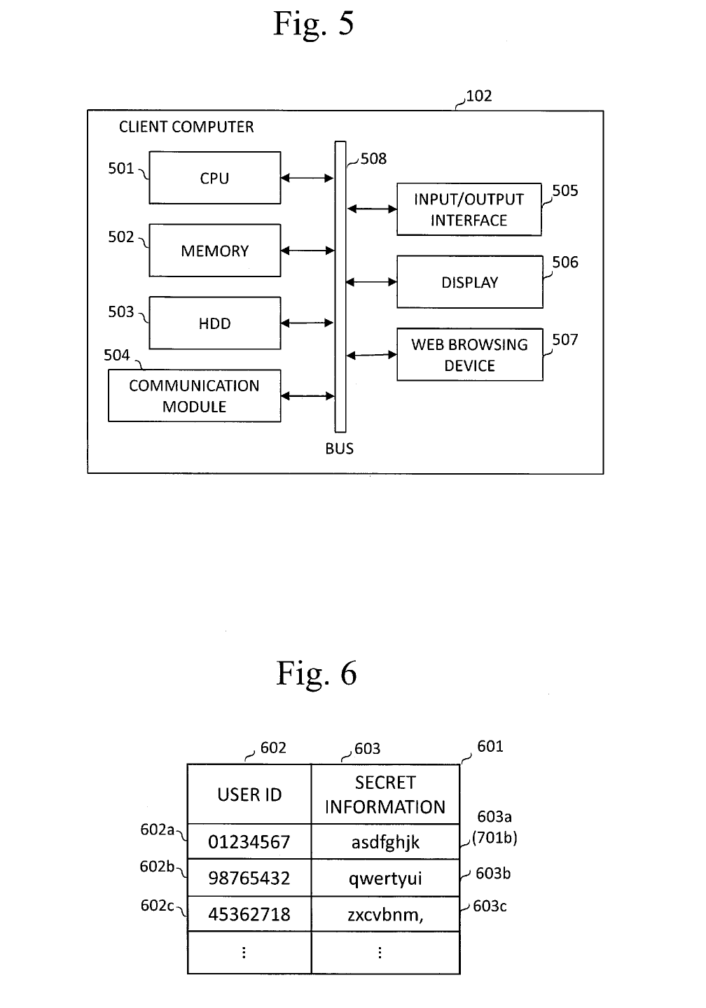

FIG. 5 is a diagram illustrating a hardware configuration of the client computer 102 according to Embodiment 1.

Referring to FIG. 5, a CPU 501, a memory 502, a hard disk drive (HDD) 503, a communication module 504, and an input/output interface 505 are connected to a bus 508. The communication module 504 is an example of a client communication unit.

In addition, a display 506 which is a display device and a Web browsing device 507 which is a browsing device that communicates with the host server 103 of the bank to receive the online banking service are connected to the bus 508 of the client computer 102. The display 506 is an example of a client display unit.

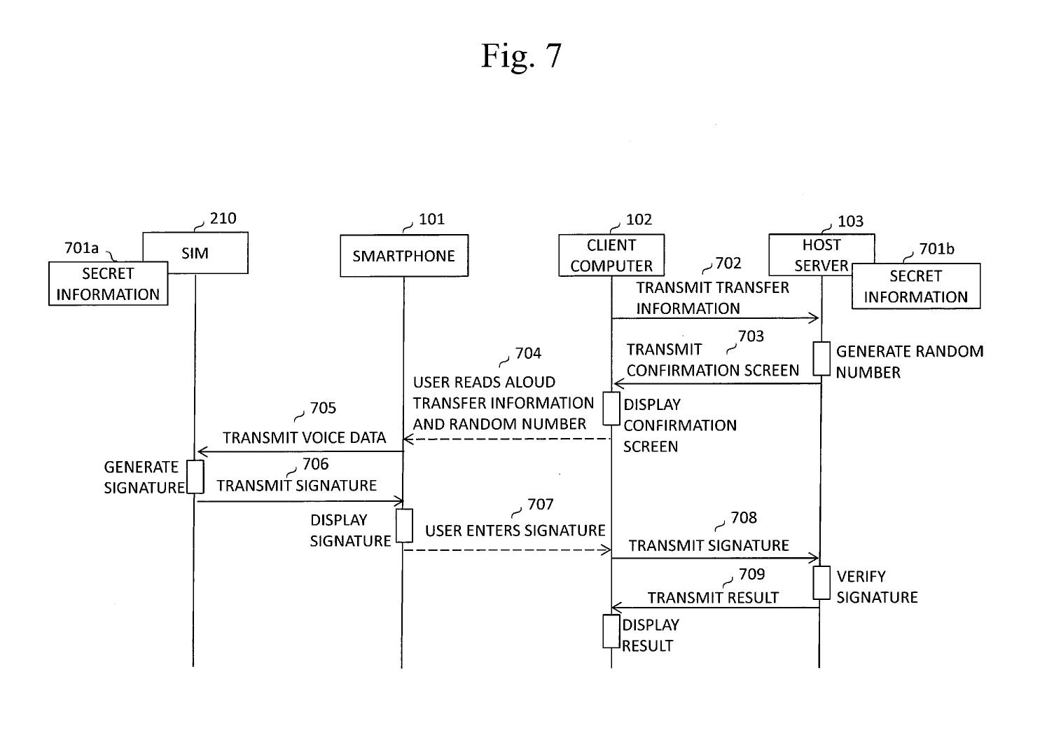

The operation of an online transaction according to Embodiment 1 will now be described with reference to FIG. 7 to FIG. 13.

FIG. 7 is a diagram illustrating an operational sequence of the online transaction according to Embodiment 1.

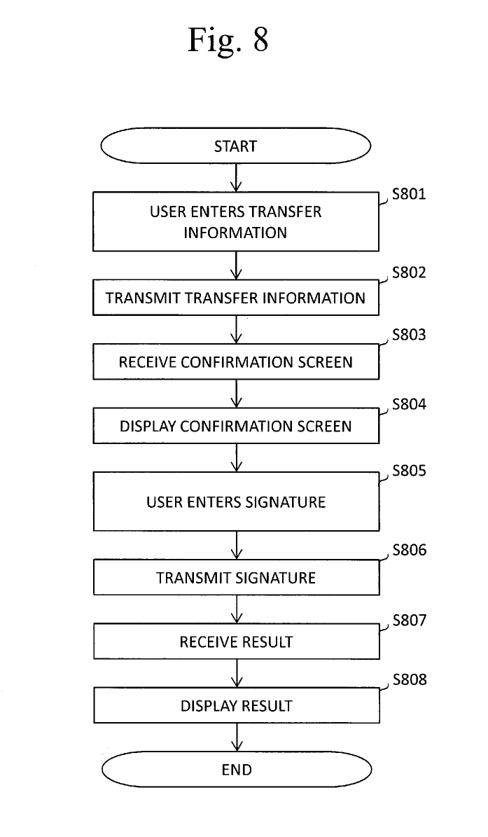

FIG. 8 is a flowchart illustrating a flow of the operation of the client computer 102 according to Embodiment 1.

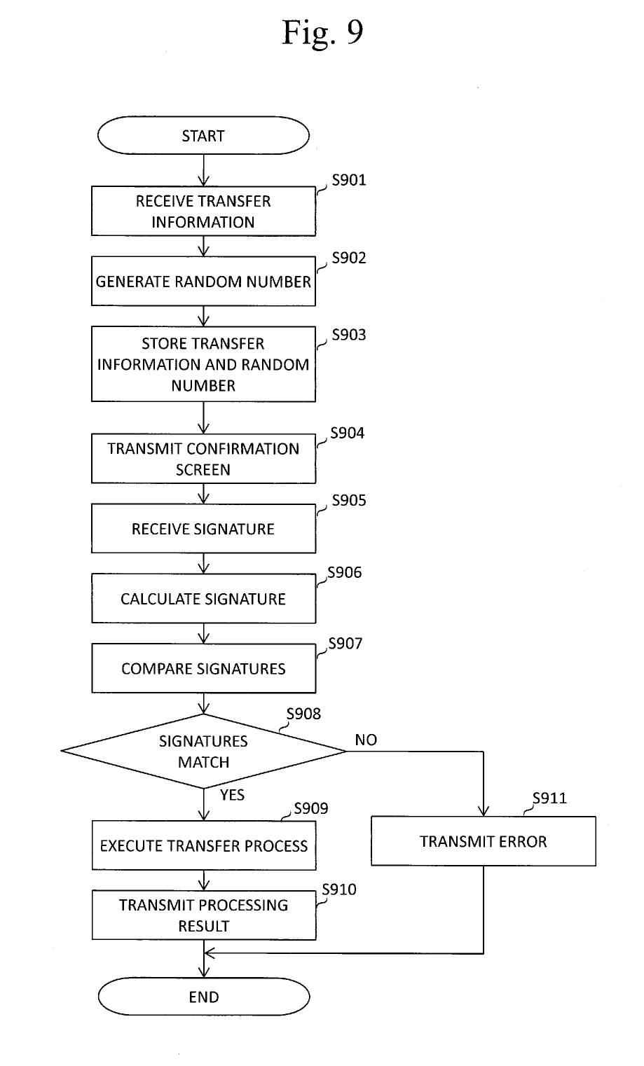

FIG. 9 is a flowchart illustrating a flow of the operation of the host server 103 according to Embodiment 1.

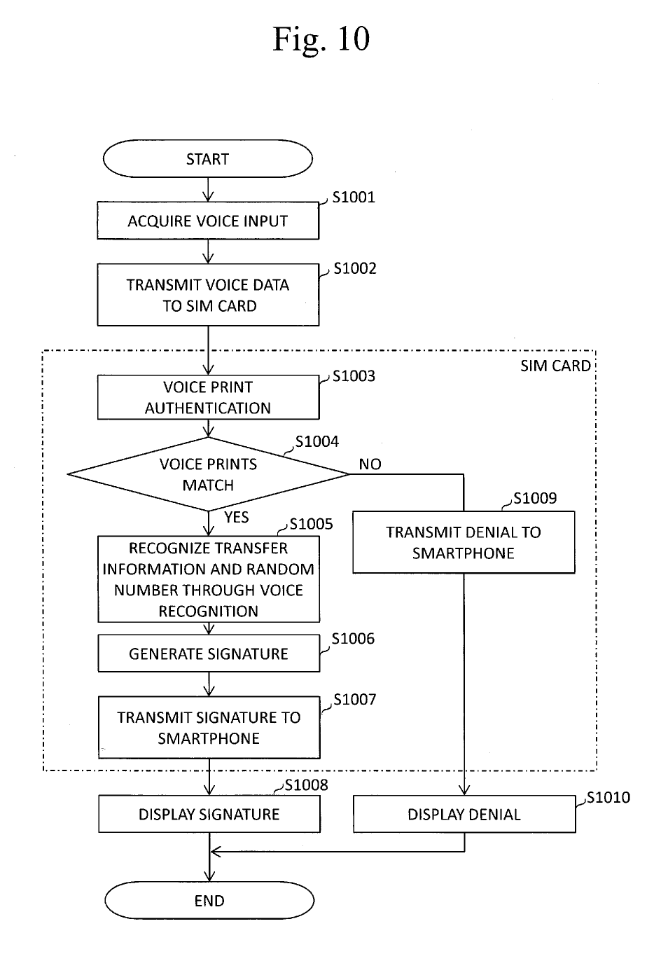

FIG. 10 is a flowchart illustrating a flow of the operation of the smartphone 101 and the SIM card 210 according to Embodiment 1.

FIG. 11 is a diagram illustrating an example of a transfer information registration table 1101 to store transfer information (a transfer destination account number 1103 and a transfer amount 1104) and a random number 1105 which are registered in the host server 103.

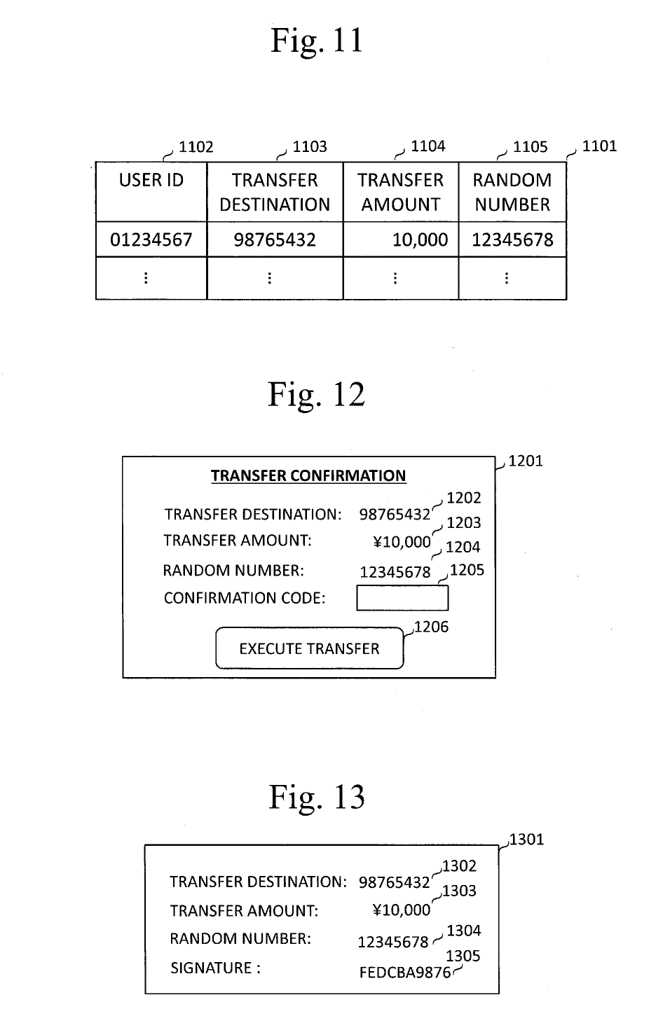

FIG. 12 is a diagram illustrating an example of a confirmation screen 1201 for a transfer that the host server 103 transmits to the client computer 102.

FIG. 13 is a diagram illustrating an example of a screen 1301 on which the smartphone 101 displays transfer information (a transfer destination account number 1302 and a transfer amount 1303), a random number 1304, and a signature 1305.

Referring to FIG. 7, to start with, the SIM card 210 of the smartphone 101 and the host server 103 of the bank share secret information 701 (701a, 701b) in advance. The secret information 701a on the SIM card 210 side is held in the secret information holding device 302 on the user-terminal side of the SIM card 210, and the secret information 701b on the host server 103 side is stored in the secret information 603 (603a) in the secret information management table 601 held by the secret information holding device 406 on the server side of the host server 103.

Next, the user logs in to the online banking service of the host server 103 from the Web browsing device 507 of the client computer 102, and enters transfer information such as a transfer destination account number and a transfer amount on a screen for performing a transfer operation from the input/output interface 505 of the client computer 102 (S801), and then transmits the transfer information to the Web server device 405 of the host server 103 (702, S802).

Next, the Web server device 405 of the host server 103 receives the transfer information from the client computer 102 (S901), then generates a random number with the random number generation device 407 (S902), and stores the received transfer information and the generated random number in the transfer information registration table 1101 held in the memory 402 or the like of the host server 103 (S903). Then, the Web server device 405 transmits the confirmation screen 1201 indicating the transfer information (a transfer destination account number 1202 and a transfer amount 1203) and a random number 1204 to the Web browsing device 507 of the client computer 102 (703, S904).

Next, the Web browsing device 507 of the client computer 102 receives the confirmation screen 1201 (S803), and displays the confirmation screen 1201 on the display 506 (S804).

Next, the user reads aloud the transfer information (the transfer destination account number 1202 and the transfer amount 1203) and the random number 1204 on the confirmation screen 1201 displayed on the display 506 of the client computer 102, so as to perform a voice input from the microphone 209 of the smartphone 101 (704).

Next, the microphone 209 of the smartphone 101 acquires the voice input (S1001), and transmits voice data to the SIM card 210 (705, S1002). The voice print authentication device 304 of the SIM card 210 which has received the voice data performs user authentication based on the voice print (S1003, S1004). For the user authentication based on the voice print, an existing speaker verification method may be used, for example.

If the voice print matches the voice print of an authorized user, the voice recognition device 305 of the SIM card 210 recognizes from the voice data the transfer information (the transfer destination account number and the transfer amount) and the random number which are the content of the input (S1005). The signature generation device 303 on the user-terminal side of the SIM card 210 generates a signature by performing keyed hashing, encryption, or the like, using the recognized transfer information and random number and the secret information 701a held in the secret information holding device 302 on the user-terminal side of the SIM card 210 (S1006). The recognized transfer information and random number and the generated signature are transmitted to the smartphone 101 (706, S1007) and displayed by the display 208 of the smartphone 101 (S1008).

On the other hand, if the voice print does not match the voice print of an authorized user in S1004, a notification of denial is transmitted to the smartphone 101 (S1009). The smartphone 101 displays the notification of denial on the display 208, and ends the processing.

Next, the user checks the transfer information (the transfer destination account number 1302 and the transfer amount 1303) and the random number 1304 that are displayed on the display 208 of the smartphone 101, and enters the displayed signature 1305 into a confirmation code input box 1205 on the confirmation screen 1201 from the input/output interface 505 of the client computer 102 (707, S805).

Next, the Web browsing device 507 of the client computer 102 transmits the signature entered by the user to the Web server device 405 of the host server 103 (708, S806).

Next, when the Web server device 405 of the host server 103 receives the signature (S905), the signature generation device 408 on the server side retrieves the transfer information (the transfer destination account number 1103 and the transfer amount 1104) and the random number 1105 that have been registered in the transfer information registration table 1101, and generates a signature in the same way as the signature generation device 303 on the user-terminal side of the SIM card 210, using the secret information 603a (7016b) registered in the secret information management table 601 in the secret information holding device 406 on the server side (S906).

Next, the signature comparison device 409 of the host server 103 compares the received signature with the calculated signature (S907, S908). If the signatures match, the transaction device 410 of the host server 103 executes a transfer process, based on the transfer information (the transfer destination account number 1103 and the transfer amount 1104) registered in the transfer information registration table 1101 (S909), and the Web server device 405 transmits a processing result to the Web browsing device 507 of the client computer 102 (709, S910).

On the other hand, if the signatures do not match, the Web server device 405 of the host server 103 transmits an error to the Web browsing device 507 of the client computer 102 (709, S911).

Finally, the Web browsing device 507 of the client computer 102 receives the result (S807), displays the result on the display 506 (S808), and ends the processing.

As described above, transfer information and a random number are input by voice and a voice print, which is a feature that can identify a user, is used for authentication of the user. Thus, since it is difficult for malware to forge the voice print, it is possible to prevent a malicious action from being performed even if malware performing a MITB attack which has infected a client computer and malware which has infected a user terminal collaborate with each other. Further, the SIM card is used. Thus, since it is difficult for malware to infect the SIM card, it is possible to prevent the malware which has infected the user terminal from performing a malicious action on the SIM card. Therefore, an online transaction with guaranteed security and credibility can be realized.

### Embodiment 2

In Embodiment 1 above, the display device (display) of the user terminal (smartphone) displays transaction information such as transfer information and a random number without performing special processing on the transaction information. Next, Embodiment 2 describes an embodiment in which a display device of a user terminal displays transaction information in accordance with a secret rule set by a user in advance. This embodiment will be described assuming that the secret rule is that the color of displayed characters changes depending on a transfer amount range. However, the secret rule is not limited to this.

In this embodiment, hardware configurations of a smartphone 101 which is a user terminal, a host server 103, and a client computer 102 are identical to those of FIG. 2, FIG. 4, and FIG. 5, respectively, described in Embodiment 1.

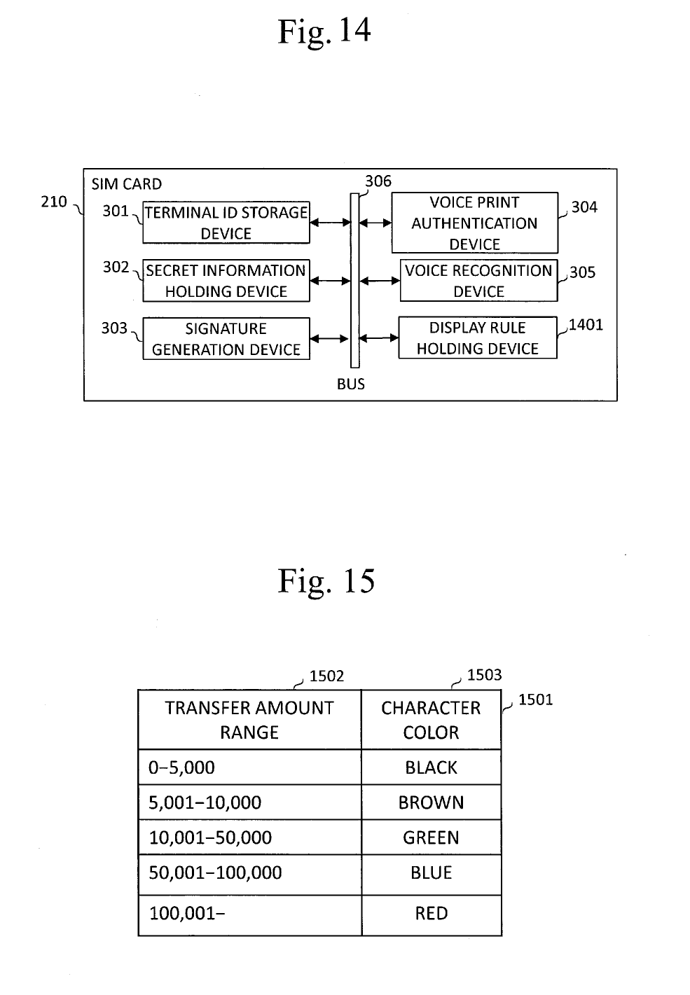

FIG. 14 is a diagram illustrating a hardware configuration of a SIM card 210 according to Embodiment 2.

Referring to FIG. 14, a terminal ID storage device 301 for fulfilling regular functions of the SIM card 210 is connected to a bus 306.

In addition, as in Embodiment 1, a secret information holding device 302 on the user-terminal side, a signature generation device 303 on the user-terminal side, a voice print authentication device 304, and a voice recognition device 305 are connected to the bus 306 of the SIM card 210. The secret information holding device 302 on the user-terminal side is a device that holds secret information shared with the host server 103 of a bank in some way in advance. The signature generation device 303 on the user-terminal side is a device that calculates a hash value or the like of transfer information to generate a signature for the transfer information. The voice print authentication device 304 is a device that authenticates a user based on a voice print of voice input from the microphone 209 of the smartphone 101. The voice recognition device 305 is a device that recognizes speech content from the voice input from the microphone 209 of the smartphone 101.

A display rule holding device 1401 is also connected to the bus 306 of the SIM card 210. The display rule holding device 1401 is an example of a display rule storage unit. The display rule holding device 1401 is a device that securely holds a display rule that defines a display method for the smartphone 101 when displaying transfer information and a random number on the display 208. The display rule is set by the user in some way in advance.

FIG. 15 is a diagram illustrating an example of a display rule table 1501 to hold a display rule.

Referring to FIG. 15, the display rule table 1501 holds a display rule that associates a transfer amount range 1502 with a character color 1503. The display rule table 1501 like this is held in the display rule holding device 1401.

The operation of an online transaction according to Embodiment 2 will now be described.

The operation is the same as that described in Embodiment 1 with reference to FIG. 7 to FIG. 13, except for the operation of S1008 of FIG. 10 in which the transfer information (the transfer destination account number 1302 and the transfer amount 1303), the random number 1304, and the signature 1305 of FIG. 13 are displayed by the display 208 of the smartphone 101.

When the display 208 of the smartphone 101 displays (the transfer destination account number 1302 and the transfer amount 1303), the random number 1304, and the signature 1305, the display 208 acquires the display rule table 1501 from the display rule holding device 1401 of the SIM card 210, and changes a character color in accordance with the display rule table 1501. For example, if the transfer amount 1303 is ¥10,000, the display 208 changes the character color to brown, in accordance with the display rule table 1501 illustrated in FIG. 15.

As described above, a display rule set by the user in advance is held in the SIM card into which malware cannot intrude, and the smartphone displays transaction information in accordance with the display rule. Thus, it is difficult for malware which has infected the smartphone to change the display without being noticed by the user. Therefore, an online transaction with enhanced security can be realized.

### Embodiment 3

In Embodiments 1 and 2 above, the user enters transfer information which is transaction information through an input having a feature that can identify the user, for example, through a voice input. This embodiment describes an embodiment in which an input by a camera is used, instead of an input having a feature that can identify the user.

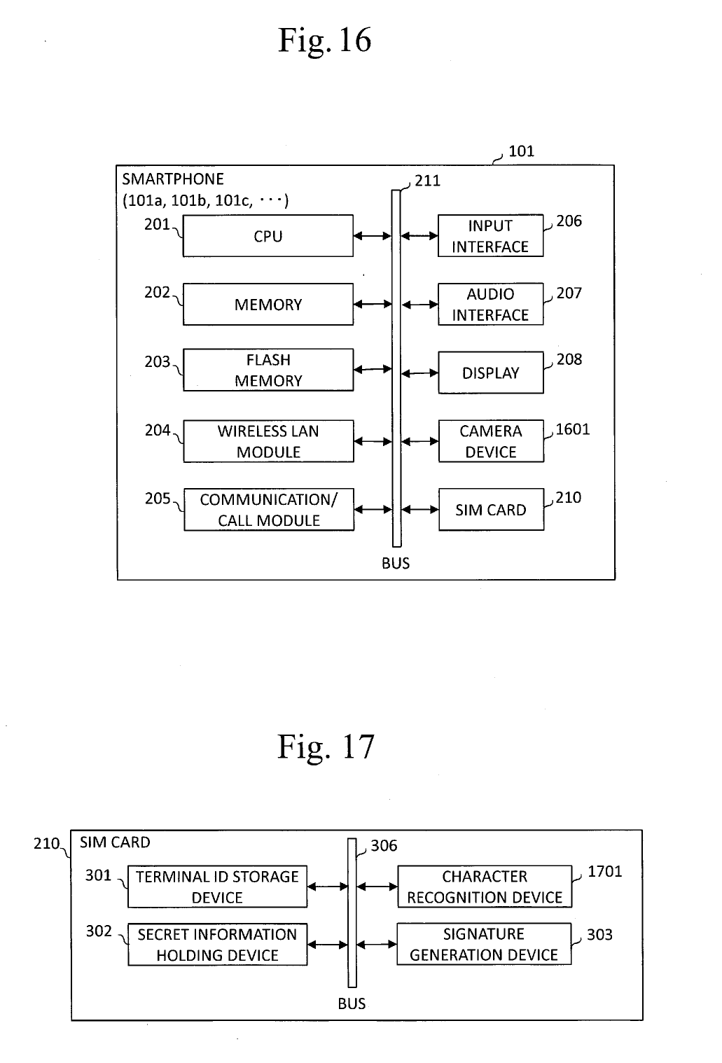

FIG. 16 is a diagram illustrating a hardware configuration of a smartphone 101 according to Embodiment 3.

Referring to FIG. 16, a CPU 201, a memory 202, a flash memory 203, a wireless LAN module 204, a communication/call module 205, an input interface 206 such as a touch panel, and an audio interface 207 are connected to a bus 211.

In addition, a display 208 which is a display device, a camera device 1601 which takes a photograph, and a SIM card 210 which is secure against intrusion by malware are connected to the bus 211 of the smartphone 101.

FIG. 17 is a diagram illustrating a hardware configuration of the SIM card 210 according to Embodiment 3.

Referring to FIG. 17, a terminal ID storage device 301 for fulfilling regular functions of the SIM card 210 is connected to a bus 306.

In addition, a secret information holding device 302 on the user-terminal side, a signature generation device 303 on the user-terminal side, and a character recognition device 1701 are connected to the bus 306 of the SIM card 210. The secret information holding device 302 on the user-terminal side is a device that holds secret information shared with a host server 103 of a bank in some way in advance. The signature generation device 303 on the user-terminal side is a device that calculates a hash value or the like of transfer information to generate a signature for the transfer information. The character recognition device 1701 is a device that recognizes characters shown in an image photographed with the camera device 1601 of the smartphone 101. The character recognition device 1701 is an example of the information extraction unit.

A hardware configuration of the host server 103 is substantially the same as the hardware configuration illustrated in FIG. 4, and a hardware configuration of a client computer 102 is substantially the same as the hardware configuration illustrated in FIG. 5.

The operation of an online transaction according to Embodiment 3 will now be described.

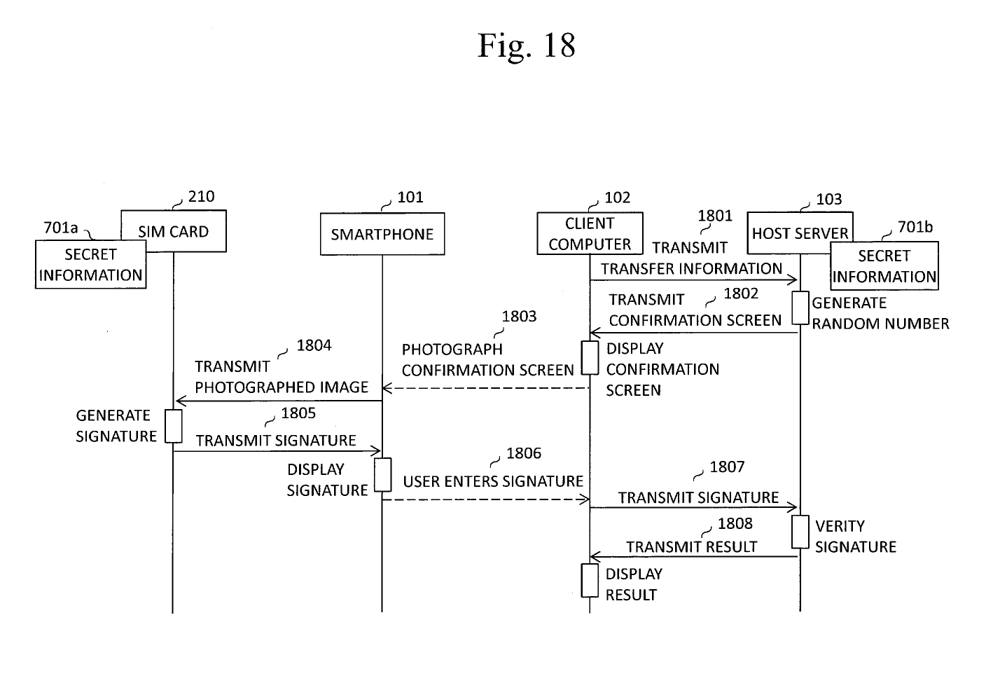

FIG. 18 is a diagram illustrating an operational sequence of the online transaction according to Embodiment 3.

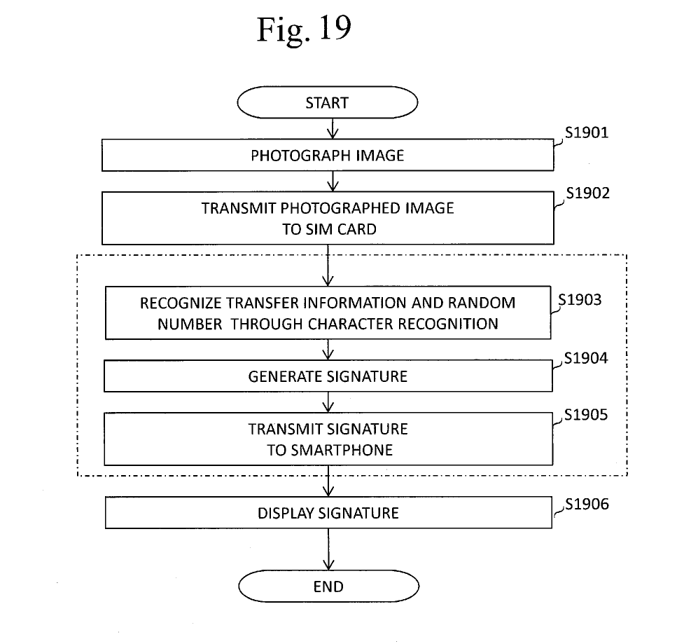

FIG. 19 is a flowchart illustrating a flow of the operation of the smartphone 101 and the SIM card 210 according to Embodiment 3.

Referring to FIG. 18, to start with, the SIM card 210 of the smartphone 101 and the host server 103 of the bank share secret information 701 (701a, 701b) in advance. The secret information 701a on the SIM card 210 side is held in the secret information holding device 302 on the user-terminal side of the SIM card 210, and the secret information 701b on the host server 103 side is stored in secret information 603 (603a) in a secret information management table 601 held in the secret information holding device 406 on the server side of the host server 103.

Next, the user logs in to the online banking service of the host server 103 from the Web browsing device 507 of the client computer 102, enters transfer information such as a transfer destination account number and a transfer amount on a screen for performing a transfer operation from the input/output interface 505 of the client computer 102, and then transmits the transfer information to the Web server device 405 of the host server 103 (1801).

Next, the Web server device 405 of the host server 103 receives the transfer information from the client computer 102, then generates a random number with the random number generation device 407, and stores the received transfer information and the generated random number in a transfer information registration table 1101 held in the memory 402 or the like of the host server 103. Then, the Web server device 405 transmits a confirmation screen 1201 indicating the transfer information (a transfer destination account number 1202 and a transfer amount 1203) and a random number 1204 to the Web browsing device 507 of the client computer 102 (1802).

Next, the Web browsing device 507 of the client computer 102 receives the confirmation screen 1201 and displays the confirmation screen 1201 on the display 506.

Next, the user photographs the confirmation screen 1201 displayed on the display 506 of the client computer 102 with the camera device 1601 of the smartphone 101 (1803, S1901). The smartphone 101 transmits the photographed image to the SIM card 210 (1804, S1902).

The character recognition device 1701 of the SIM card 210 which has received the photographed image recognizes characters shown in the photographed image to acquire the transfer information (the transfer destination account number 1202 and the transfer amount 1203) and the random number 1204 (S1903). The signature generation device 303 on the user-terminal side of the SIM card 210 generates a signature by performing keyed hashing, encryption, or the like, using the transfer information and random number which have been character-recognized and the secret information 701a held in the secret information holding device 302 on the user-terminal side of the SIM card 210 (S1904). The transfer information and random number which have been character-recognized and the generated signature are transmitted to the smartphone 101 (1805, S1905) and displayed by the display 208 of the smartphone 101 (S1906).

Next, the user checks the transfer information (a transfer destination account number 1302 and a transfer amount 1303) and a random number 1304 displayed on the display 208 of the smartphone 101, and enters a displayed signature 1305 into a confirmation code input box 1205 on the confirmation screen 1201 from the input/output interface 505 of the client computer 102 (1806).

Next, the Web browsing device 507 of the client computer 102 transmits the signature entered by the user to the Web server device 405 of the host server 103 (1807).

Next, when the Web server device 405 of the host server 103 receives the signature, the signature generation device 408 on the server side retrieves the transfer information (a transfer destination account number 1103 and a transfer amount 1104) and a random number 1105 which have been registered in the transfer information registration table 1101, and generates a signature in the same way as the signature generation device 303 on the user-terminal side of the SIM card 210, using the secret information 603a (701b) registered in the secret information management table 601 in the secret information holding device 406 on the server side.

Next, the signature comparison device 409 of the host server 103 compares the received signature with the calculated signature. If the signatures match, the transaction device 410 of the host server 103 executes a transfer process, based on the transfer information (the transfer destination account number 1103 and the transfer amount 1104) registered in the transfer information registration table 1101, and the Web server device 405 transmits a processing result to the Web browsing device 507 of the client computer 102 (1808).

On the other hand, if the signatures do not match, the Web server device 405 of the host server 103 transmits an error to the Web browsing device 507 of the client computer 102 (1808).

Finally, the Web browsing device 507 of the client computer 102 receives the result, displays the result on the display 506, and ends the processing.

As described above, image data obtained by photographing with a camera is used. Thus, since it is more difficult to tamper with image data than text data, it is possible to prevent a malicious action from being performed even if malware performing a MITB attack which has infected the client computer and malware which has infected the user terminal collaborate with each other. Further, the SIM card is used. Thus, since it is difficult for malware to infect the SIM card, it is possible to prevent the malware which has infected the user terminal from performing a malicious action on the SIM card. Therefore, an online transaction with guaranteed security and credibility can be realized.

### Embodiment 4

In Embodiment 3 above, it is possible for sophisticated malware to tamper with an image photographed with a camera. This embodiment describes an embodiment which prevents tampering of an image by sophisticated malware.

In this embodiment, hardware configurations of a host server 103 and a client computer 102 are identical to those of FIG. 4 and FIG. 5, respectively, described in Embodiment 1.

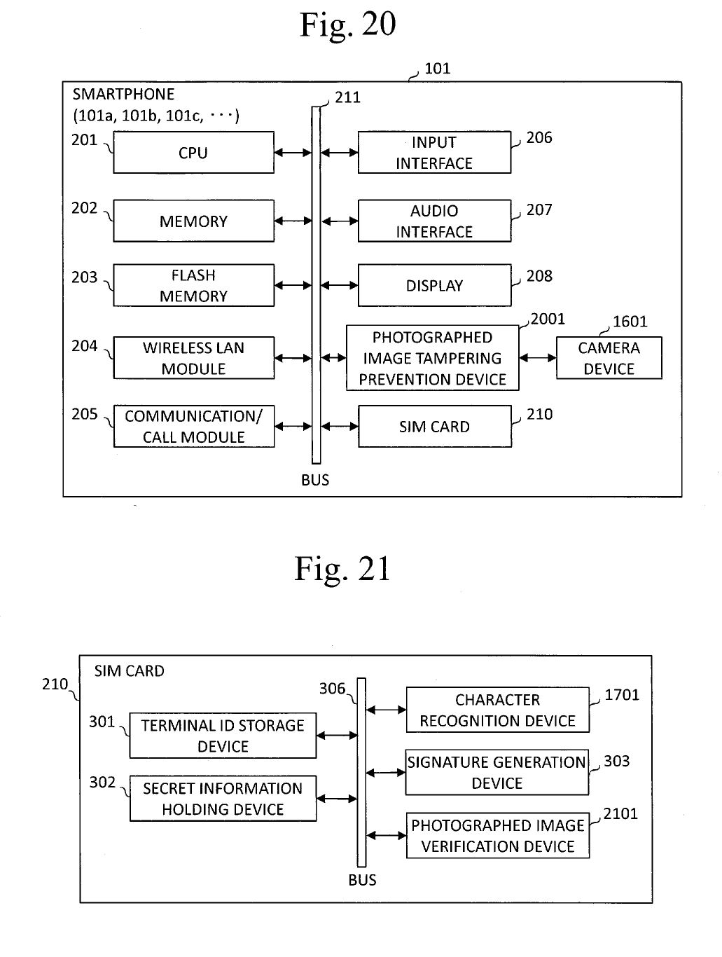

FIG. 20 is a diagram illustrating a hardware configuration of a smartphone 101 according to Embodiment 4.

Referring to FIG. 20, a CPU 201, a memory 202, a flash memory 203, a wireless LAN module 204, a communication/call module 205, an input interface 206 such as a touch panel, and an audio interface 207 are connected to a bus 211.

In addition, a display 208 which is a display device, a camera device 1601 which takes a photograph via a photographed image tampering prevention device 2001, and a SIM card 210 which is secure against intrusion by malware are connected to the bus 211 of the smartphone 101. The photographed image tampering prevention device 2001 is a device that shares secret information with a photographed image verification device 2101 of the SIM card 210 in some way in advance, and using the secret information, prevents tampering of photographed image data by attaching a signature such as a keyed hash value to the photographed image data or by encrypting the photographed image data. The photographed image tampering prevention device 2001 is an example of an image tampering prevention unit.

FIG. 21 is a diagram illustrating a hardware configuration of the SIM card 210 according to Embodiment 4.

Referring to FIG. 21, a terminal ID storage device 301 for fulfilling regular functions of the SIM card 210 is connected to a bus 306.

In addition, as in Embodiment 3, a secret information holding device 302 on the user-terminal side, a signature generation device 303 on the user-terminal side, and a character recognition device 1701 are connected to the bus 306 of the SIM card 210. The secret information holding device 302 on the user-terminal side is a device that holds secret information shared with the host server 103 of a bank in some way in advance. The signature generation device 303 on the user-terminal side is a device that calculates a hash value or the like of transfer information to generate a signature for the transfer information. The character recognition device 1701 is a device that recognizes characters shown in an image photographed with the camera device 1601 of the smartphone 101.

The photographed image verification device 2101 is also connected to the bus 306 of the SIM card 210. The photographed image verification device 2101 is a device that shares secret information with the photographed image tampering prevention device 2001 of the smartphone 101 in some way in advance, and using the secret information, verifies that photographed image data to which a signature such as a keyed hash value is attached or which has been encrypted is legitimate. The photographed image verification device 2101 verifies that the photographed image is legitimate by using the secret information to generate a signature, such as a keyed hash value, for the image data and comparing the generated signature with the signature attached to the photographed image data for verification, or by using the secret information to decrypt the encrypted image data and confirming that the encrypted image data has been decrypted correctly.

The operation of an online transaction according to Embodiment 4 will now be described.

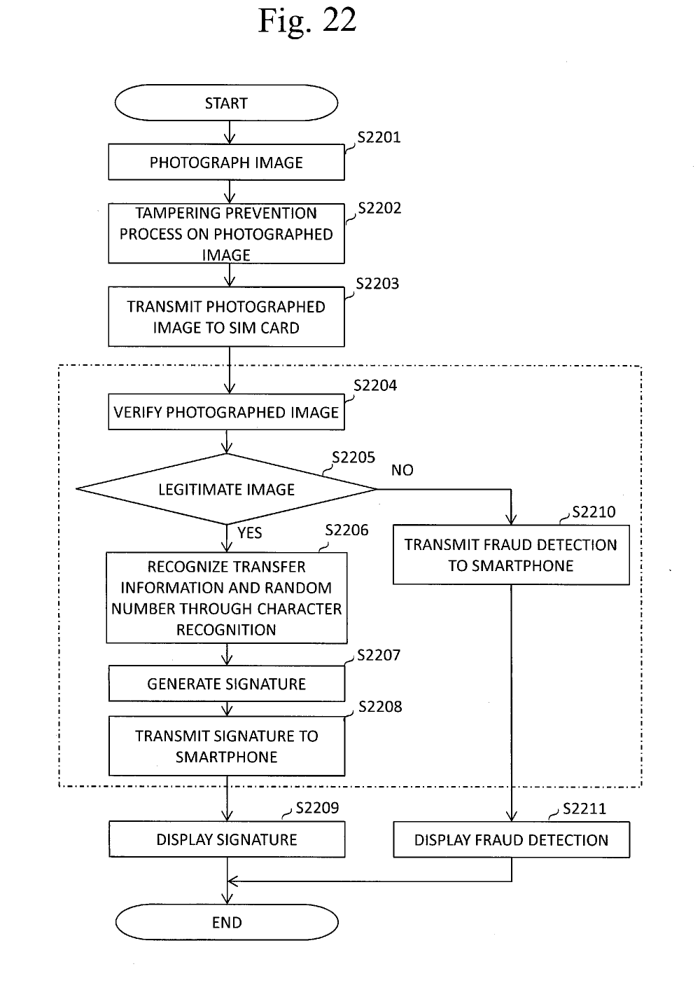

The operation is substantially the same as in Embodiment 3, except for the operation after the smartphone 101 photographs the confirmation screen 1201 (1803) in FIG. 18 until S1903 of FIG. 19 in which the transfer information (the transfer destination account number 1202 and the transfer amount 1203) and the random number 1204 are character-recognized. The operation after the smartphone 101 photographs the confirmation screen 1201 until the transfer information (the transfer destination account number 1202 and the transfer amount 1203) and the random number 1204 are character-recognized will be described hereinafter with reference to FIG. 22.

FIG. 22 is a flowchart illustrating a flow of the operation of the smartphone 101 and the SIM card 210 according to Embodiment 4.

Referring to FIG. 22, when the smartphone 101 photographs an image with the camera device 1601 (S2201), the photographed image tampering prevention device 2001 of the smartphone 101 performs a tampering prevention process on the photographed image by attaching a signature or by encryption (S2202), and then transmits the photographed image to the SIM card 210 (1804, S2203). The image device verification device 2101 of the SIM card 210 which has received the photographed image verifies the photographed image to determine whether or not it is a legitimate image (S2204, S2205).

If the photographed image is legitimate as a result of determination in S2205, the character recognition device 1701 recognizes characters shown in the photographed image to acquire the transfer information (the transfer destination account number 1202 and the transfer amount 1203) and the random number 1204 (S2206). The operation thereafter of S2207 to S2209 is substantially the same as in Embodiment 3.

On the other hand, if the photographed image is not legitimate, a fraud notification notifying that the image is fraudulent is transmitted to the smartphone 101 (S2210), the fraud notification is displayed by the display 208 of the smartphone 101 (S2211), and the processing ends.

As described above, the photographed image tampering prevention device of the smartphone and the photographed image verification device of the SIM card share secret information in advance, and the secret information is used to detect tampering. Thus, even if the smartphone is infected with malware, tampering of a photographed image by the malware can be prevented. Therefore, an online transaction with enhanced security can be realized.

### Embodiment 5

In Embodiments 3 and 4 above, the display device (display) of the user terminal (smartphone) displays transaction information such as transfer information and a random number without performing special processing on the transaction information. Next, Embodiment 5 describes an embodiment in which a display device of a user terminal displays transaction information in accordance with a secret rule set by a user in advance. This embodiment corresponds to a case in which the display method of the user terminal described in Embodiment 2 is applied to Embodiments 3 and 4. This embodiment will be described assuming that the secret rule is that the color of displayed characters changes depending on a transfer amount range. However, the secret rule is not limited to this.

In this embodiment, a hardware configuration of a smartphone 101 which is a user terminal is identical to that of FIG. 16 described in Embodiment 3, and hardware configurations of a host server 103 and a client computer 102 are identical to those of FIG. 4 and FIG. 5, respectively, described in Embodiment 1.

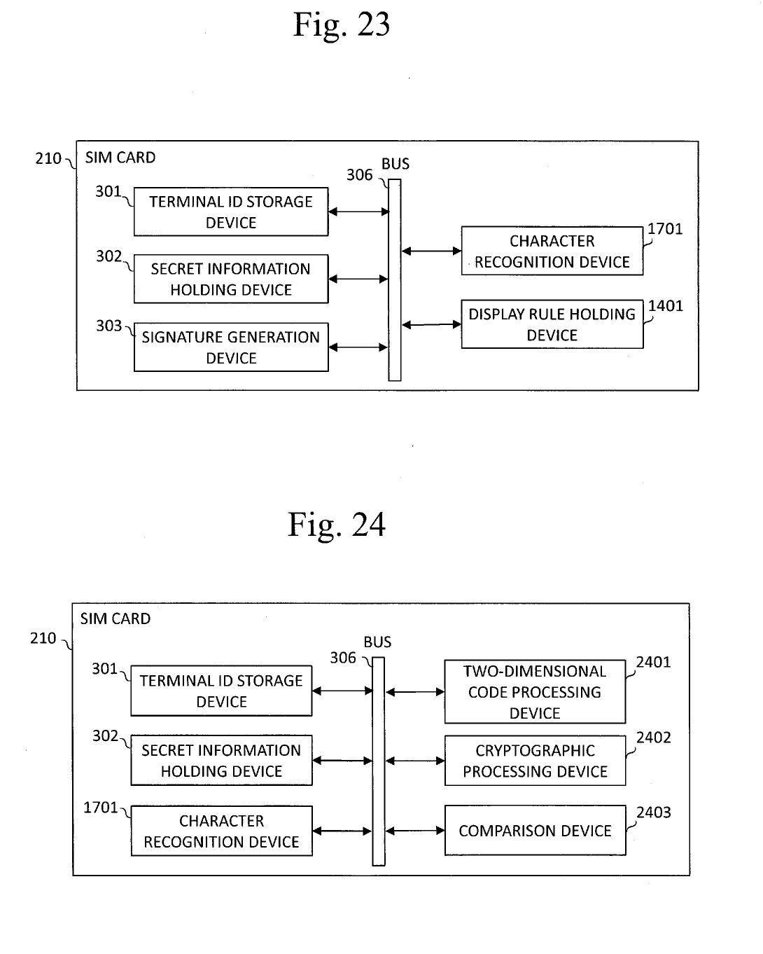

FIG. 23 is a diagram illustrating a hardware configuration of a SIM card 210 according to Embodiment 5.

Referring to FIG. 23, a terminal ID storage device 301 for fulfilling regular functions of the SIM card 210 is connected to a bus 306.

In addition, as in Embodiment 3, a secret information holding device 302 on the user-terminal side, a signature generation device 303 on the user-terminal side, and a character recognition device 1701 are connected to the bus 306 of the SIM card 210. The secret information holding device 302 on the user-terminal side is a device that holds secret information shared with the host server 103 of a bank in some way in advance. The signature generation device 303 on the user-terminal side is a device that calculates a hash value or the like of transfer information to generate a signature for the transfer information. The character recognition device 1701 is a device that recognizes characters shown in an image photographed with the camera device 1601 of the smartphone 101.

A display rule holding device 1401 is also connected to the bus 306 of the SIM card 210. The display rule holding device 1401 is a device that securely holds a display rule that defines a display method for the smartphone 101 when displaying transfer information and a random number on the display 208. As in Embodiment 3, the display rule is held in the display rule table 1501 illustrated in FIG. 15, and is set by the user in some way in advance.

The operation of an online transaction according to Embodiment 5 will now be described.

The operation is substantially the same as in Embodiment 3, except for the operation of S1906 of FIG. 19 in which the transfer information (the transfer destination account number 1302 and the transfer amount 1303), the random number 1304, and the signature 1305 of FIG. 13 are displayed by the display 208 of the smartphone 101.

When the display 208 of the smartphone 101 displays (the transfer destination account number 1302 and the transfer amount 1303), the random number 1304, and the signature 1305, the display 208 acquires the display rule table 1501 from the display rule holding device 1401 of the SIM card 210, and changes a character color in accordance with the display rule table 1501. For example, if the transfer amount 1303 is ¥10,000, the display 208 changes the character color to brown in accordance with the display rule table 1501 illustrated in FIG. 15.

As described above, a display rule set by the user in advance is held in the SIM card into which malware cannot intrude, and the smartphone displays transaction information in accordance with the display rule. Thus, it is difficult for malware which has infected the smartphone to change the display without being noticed by the user. Therefore, an online transaction with enhanced security can be realized.

### Embodiment 6

In Embodiments 3 to 5 above, transaction information (transfer information and a random number) is displayed in text on the confirmation screen, and the processing is performed using only the information obtained through character recognition from the confirmation screen photographed with the camera of the user terminal. This embodiment describes an embodiment which uses not only transaction information displayed on a confirmation screen but also a two-dimensional code. This embodiment will be described as an embodiment in which a one-time password is used for authentication of a transaction. However, substantially the same processing can also be performed using a keyed hash operation, a random number, and a signature, and the one-time password is a non-limiting example.

In this embodiment, a hardware configuration of a client computer 102 is identical to that of FIG. 5 described in Embodiment 1. A hardware configuration of a smartphone 101 is identical to that of FIG. 16 described in Embodiment 3.

FIG. 24 is a diagram illustrating a hardware configuration of a SIM card 210 according to Embodiment 6.

Referring to FIG. 24, a terminal ID storage device 301 for fulfilling regular functions of the SIM card 210 is connected to a bus 306.

In addition, a secret information holding device 302 on the user-terminal side, a character recognition device 1701, a two-dimensional code processing device 2401, a cryptographic processing device 2402 on the user-terminal side, and a comparison device 2403 on the user-terminal side are connected to the bus 306 of the SIM card 210. The secret information holding device 302 on the user-terminal side is a device that holds secret information shared with a host server 103 of a bank in some way in advance. The character recognition device 1701 is a device that recognizes characters shown in an image photographed with the camera device 1601 of the smartphone 101. The two-dimensional code processing device 2401 is a device that recognizes a two-dimensional code included in an image photographed with the camera device 1601 of the smartphone 101 to acquire data from the two-dimensional code. The cryptographic processing device 2402 on the user-terminal side is a device that performs an encryption process and a keyed hash operation process, using the secret information held in the secret information holding device 302 on the user-terminal side. The comparison device 2403 on the user-terminal side is a device that compares the transfer information character-recognized by the character recognition device 1701 with the transfer information obtained from the data acquired by the two-dimensional code processing device 2401 and outputs a comparison result. The two-dimensional code processing device 2401 is an example of the information extraction unit, the cryptographic processing device 2402 is an example of the authentication information generation unit, and the comparison device 2403 is an example of the verification unit.

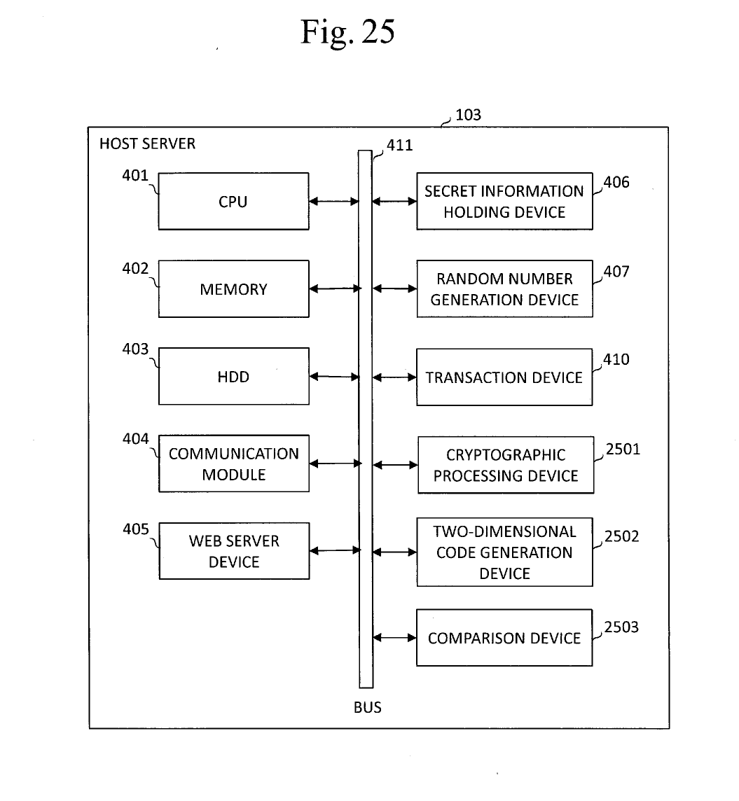

FIG. 25 is a diagram illustrating a hardware configuration of the host server 103 according to Embodiment 6.

Referring to FIG. 25, a CPU 401, a memory 402, a hard disk drive (HDD) 403, and a communication module 404 are connected to a bus 411.

In addition, a Web server device 405 which is an online transaction server, a secret information holding device 406 on the server side, a random number generation device 407, a transaction device 410, a cryptographic processing device 2501 on the server side, a two-dimensional code generation device 2502, and a comparison device 2503 on the server side are connected to the bus 411 of the host server 103. The Web server device 405 is a device that provides an online banking service to the client computer 102. The secret information holding device 406 on the server side is a device that holds the secret information shared with the smartphone 101 in some way in advance. The random number generation device 407 is a device that generates a one-time password including a random character string or generates a random number. The transaction device 410 is a device that processes a transaction such as a transfer. The cryptographic processing device 2501 on the server side is a device that performs an encryption process and a keyed hash operation process, using the secret information held in the secret information holding device 406 on the server side. The two-dimensional code generation device 2502 is a device that generates a two-dimensional code from input data. The comparison device 2503 on the server side is a device that compares the information received by the Web server device 405 with the one-time password or random number generated by the random number generation device 407 and outputs a comparison result. The cryptographic processing device 2501 and the two-dimensional code generation device 2502 are examples of a server signature generation unit, and the comparison device 2503 is an example of a comparison unit.

The secret information holding device 406 on the server side of the host server 103 holds a secret information management table 601 which stores a user ID 602 (602a, 602b, 603c, and so on) and corresponding secret information 603 (603a, 603b, 603c, and so on) for each user, as illustrated as an example in FIG. 6.

The operation of an online transaction according to Embodiment 6 will now be described.

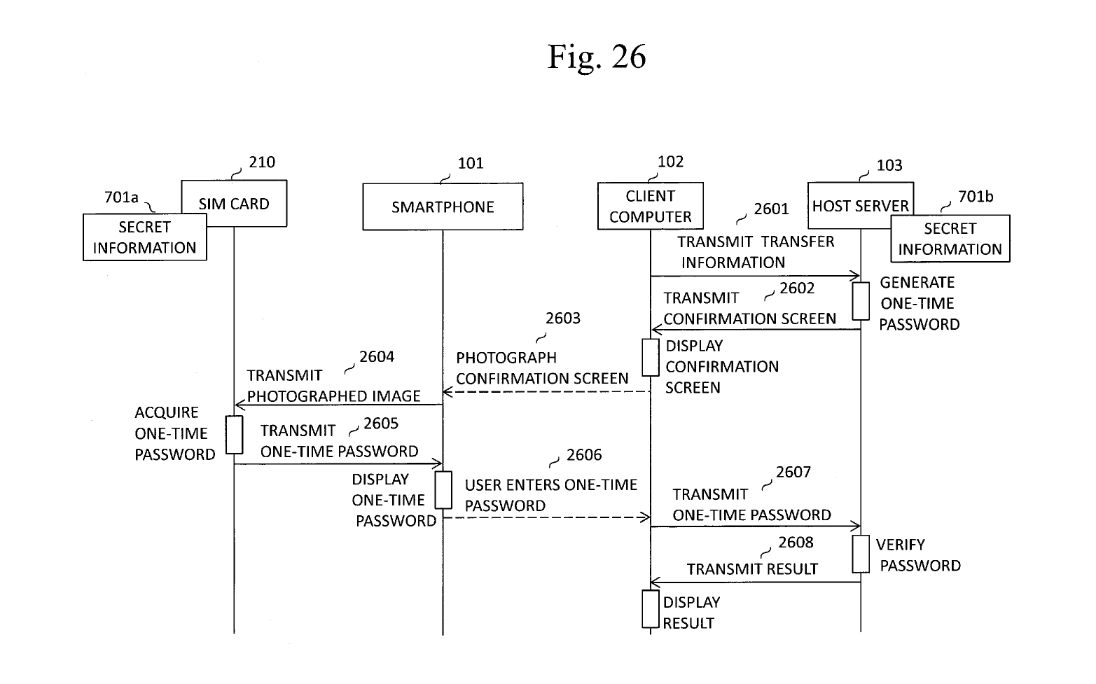

FIG. 26 is a flowchart illustrating an operational sequence of the online transaction according to Embodiment 6.

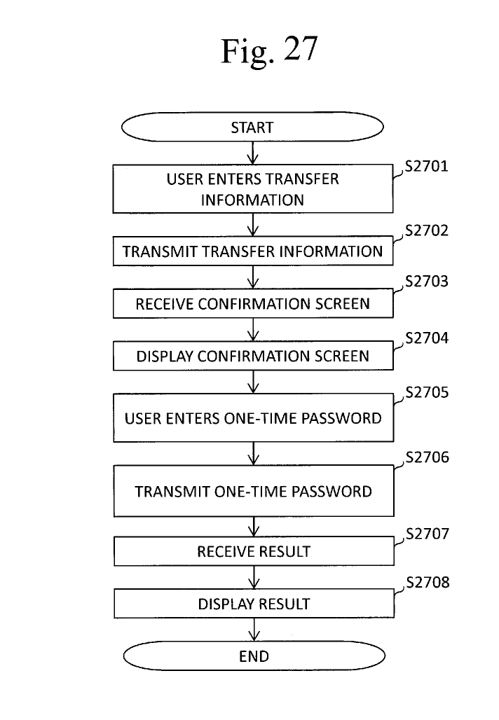

FIG. 27 is a flowchart illustrating a flow of the operation of the client computer 102 according to Embodiment 6.

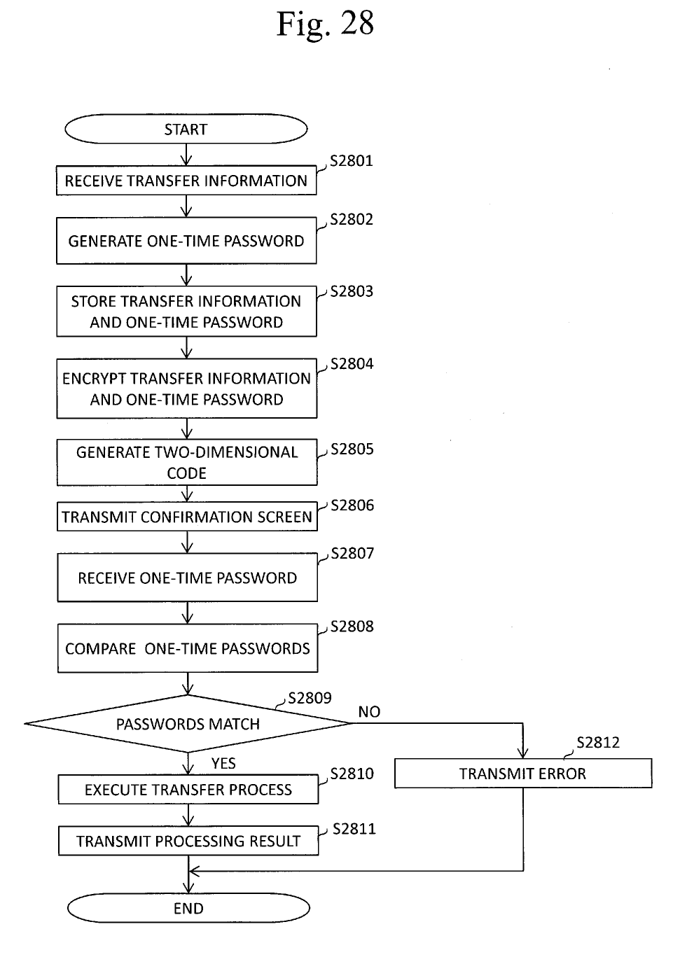

FIG. 28 is a flowchart illustrating a flow of the operation of the host server 103 according to Embodiment 6.

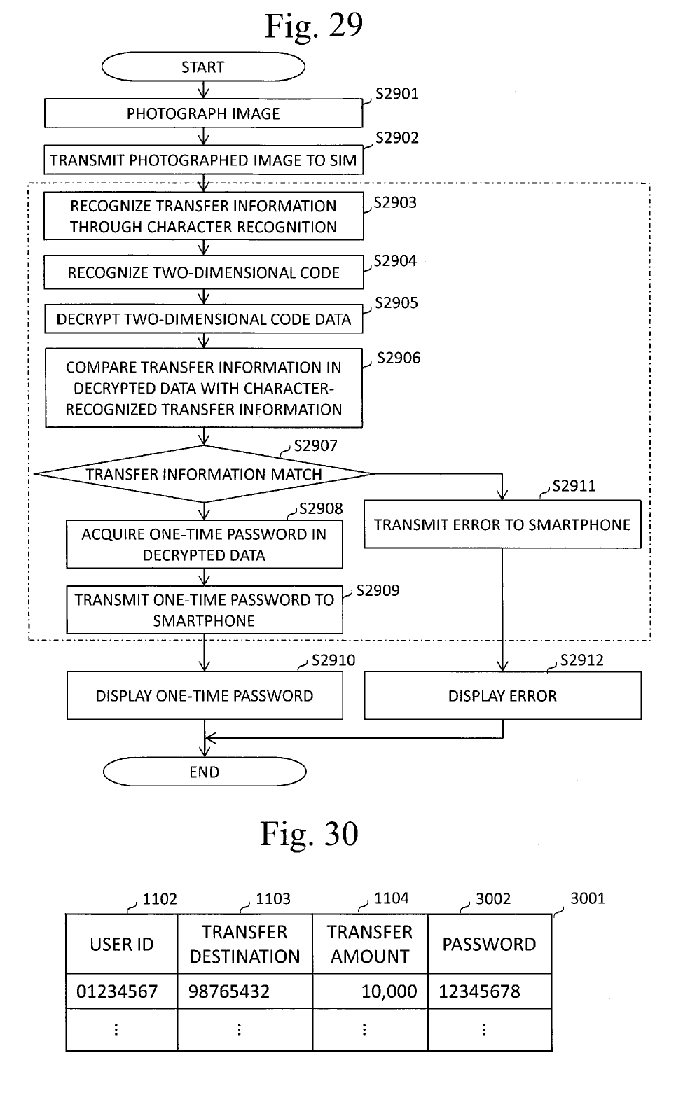

FIG. 29 is a flowchart illustrating a flow of the operation of the smartphone 101 and the SIM card 210 according to Embodiment 6.

FIG. 30 is a diagram illustrating an example of a transfer information registration table 3001 to store transfer information (a transfer destination account number 1103 and a transfer amount 1104) and a one-time password or random number 3002 which are registered in the host server 103.

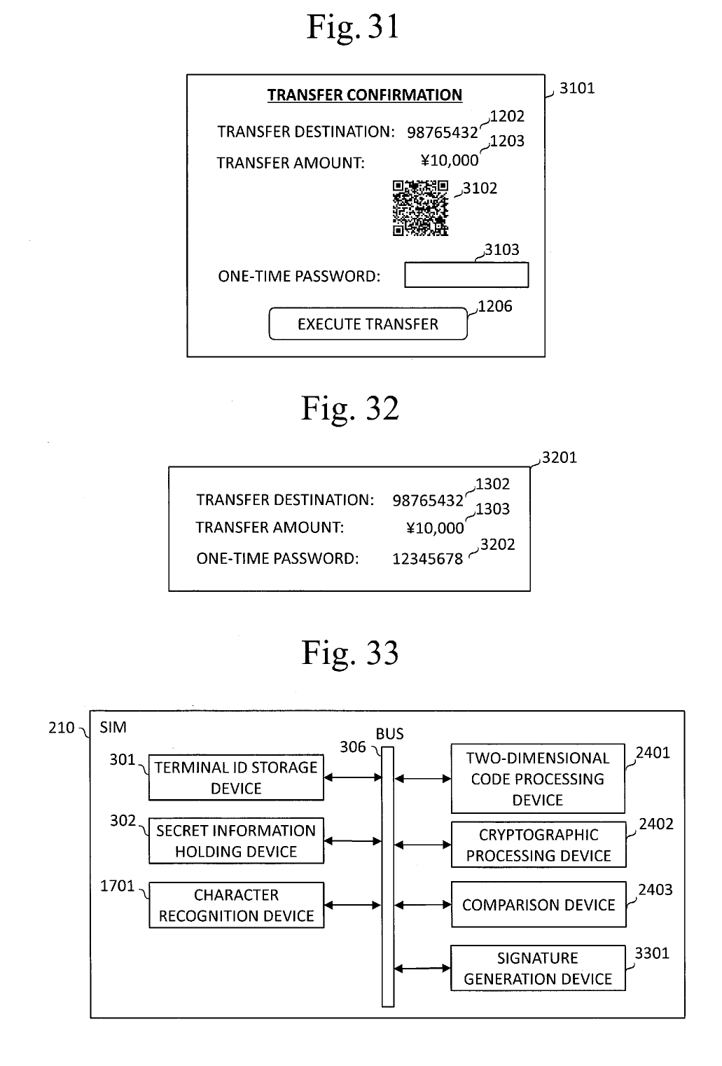

FIG. 31 is a diagram illustrating an example of a confirmation screen 3101 for a transfer that the host server 103 transmits to the client computer 102.

FIG. 32 is a diagram illustrating an example of a screen 3201 on which the smartphone 101 displays transfer information (a transfer destination account number 1302 and a transfer amount 1303) and a one-time password or signature 3202.

Referring to FIG. 26, to start with, the SIM card 210 of the smartphone 101 and the host server 103 of the bank share secret information 701 (701a, 701b) in advance. The secret information 701a on the SIM card 210 side is held in the secret information holding device 302 on the user-terminal side of the SIM card 210, and the secret information 701b on the host server 103 side is stored in the secret information 603 (603a) in the secret information management table 601 held in the secret information holding device 406 on the server side of the host server 103.

Next, the user logs in to the online banking service of the host server 103 from the Web browsing device 507 of the client computer 102, and enters transfer information such as a transfer destination account number and a transfer amount on a screen for performing a transfer operation from the input/output interface 505 of the client computer 102 (S2701), and then transmits the transfer information to the Web server device 405 of the host server 103 (2601, S2702).

Next, the Web server device 405 of the host server 103 receives the transfer information from the client computer 102 (S2801), then generates a one-time password with the random number generation device 407 (S2802), and stores the received transfer information and the generated one-time password in the transfer information registration table 3001 held in the memory 402 or the like of the host server 103 (S2803). Then, the cryptographic processing device 2501 on the server side encrypts the transfer information and the one-time password, using the secret information 603a (701b) held in the secret information management table 601 of the secret information holding device 406 on the server side (S2804), and the two-dimensional code generation device 2502 generates a two-dimensional code, using the encrypted data as input (S2805). The Web server device 405 transmits a confirmation screen 3101 indicating the transfer information (a transfer destination account number 1202 and a transfer amount 1203) and a two-dimensional code 3102 to the Web browsing device 507 of the client computer 102 (2602, S2806).

Next, the Web browsing device 507 of the client computer 102 receives the confirmation screen 3101 (S2703) and displays the confirmation screen 3101 on the display 506 (S2704).

Next, the user photographs the confirmation screen 3101 displayed on the display 506 of the client computer 102 with the camera device 1601 of the smartphone 101 (2603, S2901). The smartphone 101 transmits the photographed image to the SIM card 210 (2604, S2902).

The character recognition device 1701 of the SIM card 210 which has received the photographed image recognizes characters shown in the photographed image to acquire the transfer information (the transfer destination account number 1202 and the transfer amount 1203) (S2903). The two-dimensional code processing device 2401 recognizes the two-dimensional code 3102 shown in the photographed image to acquire data from the two-dimensional code 3102 (S2904). The cryptographic processing device 2402 on the user-terminal side decrypts the data acquired from the two-dimensional code 3102, using the secret information 701a held in the secret information holding device 302 on the user-terminal side, to acquire the transfer information and the one-time password (S2905).

Next, the comparison device 2403 on the user-terminal side compares the transfer information acquired by the character recognition device 1701 with the transfer information acquired by the cryptographic processing device 2402 on the user-terminal side to determine whether these pieces of the transfer information match (S2906, S2907). If the pieces of the transfer information match, the one-time password acquired by the cryptographic processing device 2402 on the user-terminal side (S2908) is transmitted to the smartphone 101 together with the transfer information (2605, S2909) and displayed by the display 208 of the smartphone 101 (S2910).

On the other hand, if the pieces of the transfer information do not match as a result of determination in S2907, an error notification is transmitted to the smartphone 101 (S2911), an error is displayed by the display 208 of the smartphone 101 (S2912), and the processing ends.

Next, the user checks the transfer information (the transfer destination account number 1302 and the transfer amount 1303) displayed on the display 208 of the smartphone 101, enters the one-time password 3202 into a one-time password input box 3103 on the confirmation screen 3101 from the input/output interface 505 of the client computer 102 (2606, S2705).

Next, the Web browsing device 507 of the client computer 102 transmits the one-time password entered by the user to the Web server device 405 of the host server 103 (2607, S2706).

Next, when the Web server device 405 of the host server 103 receives the one-time password (S2807), the comparison device 2503 on the server side retrieves the one-time password 3002 registered in the transfer information registration table 3001, and compares the retrieved one-time password with the received one-time password to determine whether the one-time passwords match (S2808, S2809). If the one-time passwords match, the transaction device 410 of the host server 103 executes a transfer process, based on the transfer information (the transfer destination account number 1103 and the transfer amount 1104) registered in the transfer information registration table 3001 (S2810), and the Web server device 405 transmits a processing result to the Web browsing device 507 of the client computer 102 (2608, S2811).

On the other hand, if the one-time passwords do not match as a result of determination in S2809, the Web server device 405 of the host server 103 transmits an error (2608, S2812).

Finally, the Web browsing device 507 of the client computer 102 receives the result (S2707), displays the result on the display 506 (S2708), and ends the processing.

As described above, not only transaction information represented by characters but also a two-dimensional code is used to compare the transaction information which has been character-recognized with the transaction information embedded in the two-dimensional code. Thus, it is more difficult to tamper with the transaction information. Therefore, it is difficult to perform a malicious action even if malware performing a MITB attack which has infected a client computer and malware which has infected a user terminal collaborate with each other. Further, the SIM card is used. This, since it is difficult for malware to infect the SIM card, it is possible to prevent the malware which has infected the user terminal from performing a malicious action on the SIM card. Therefore, an online transaction with guaranteed security and credibility can be realized.

### Embodiment 7

In Embodiment 6 above, the host server transmits transaction information (transfer information) by embedding the transaction information as it is in a two-dimensional code without attaching a signature to the transaction information, and the user terminal compares the transaction information. This embodiment describes an embodiment in which a host server transmits a signature for transaction information (transfer information) by embedding the signature in a two-dimensional code, and a user terminal compares the signature. This embodiment will be described using an example in which a one-time password is used. However, substantially the same processing can also be performed using a keyed hash operation, a random number, and a signature, and the one-time password is a non-limiting example. In this embodiment, a signature is attached using a hash operation. However, the method for attaching a signature is not limited to the hash operation.

In this embodiment, a hardware configuration of a client computer 102 is identical to that of FIG. 5 described in Embodiment 1. A hardware configuration of a smartphone 101 is identical to that of FIG. 16 described in Embodiment 3.

FIG. 33 is a diagram illustrating a hardware configuration of a SIM card 210 according to Embodiment 7.

Referring to FIG. 33, a terminal ID storage device 301 for fulfilling regular functions of the SIM card 210 is connected to a bus 306.

In addition, as in Embodiment 6, a secret information holding device 302 on the user-terminal side, a character recognition device 1701, a two-dimensional code processing device 2401, a cryptographic processing device 2402 on the user-terminal side, and a comparison device 2403 on the user-terminal side are connected to the bus 306 of the SIM card 210. A signature calculation device 3301 on the user-terminal side is also connected to the bus 306 of the SIM card 210. The secret information holding device 302 on the user-terminal side is a device that holds secret information shared with a host server 103 of a bank in some way in advance. The character recognition device 1701 is a device that recognizes characters shown in an image photographed with the camera device 1601 of the smartphone 101. The two-dimensional code processing device 2401 is a device that recognizes a two-dimensional code included in an image photographed with the camera device 1601 of the smartphone 101 to acquire data from the two-dimensional code. The cryptographic processing device 2402 on the user-terminal side is a device that performs an encryption process and a keyed hash operation process, using the secret information held in the secret information holding device 302 on the user-terminal side. The signature calculation device 3301 on the user-terminal side is a device that calculates a signature for the transfer information character-recognized by the character recognition device 1701. The comparison device 2403 on the user-terminal side is a device that compares the signature calculated by the signature calculation device 3301 on the user-terminal side with the signature obtained from the data acquired by the two-dimensional code processing device 2401, and outputs a comparison result. The signature calculation device 3301 is an example of the signature generation unit.

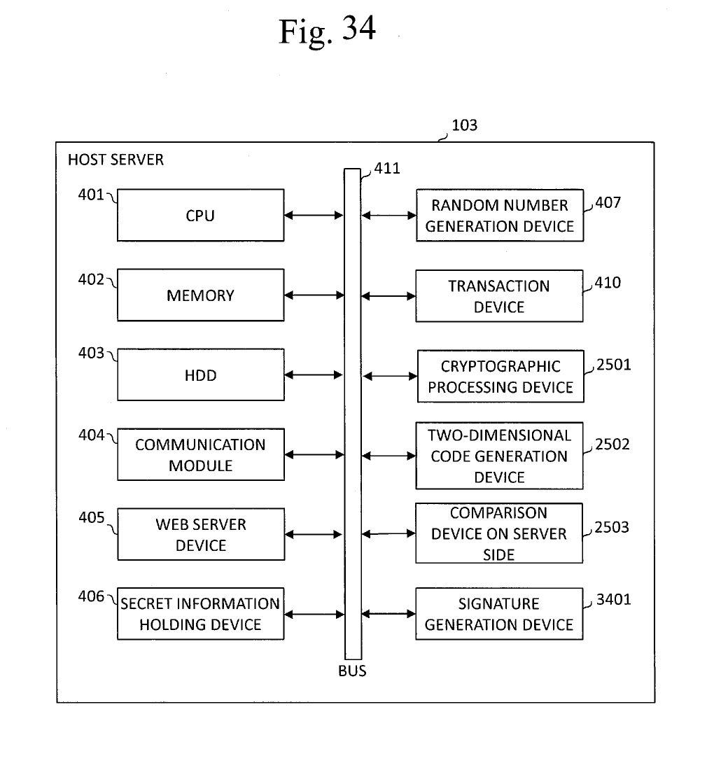

FIG. 34 is a diagram illustrating a hardware configuration of the host server 103 according to Embodiment 7.

Referring to FIG. 34, a CPU 401, a memory 402, a hard disk drive (HDD) 403, and a communication module 404 are connected to a bus 411.

In addition, a Web server device 405 which is an online transaction server, a secret information holding device 406 on the server side, a random number generation device 407, a transaction device 410, a cryptographic processing device 2501 on the server side, a two-dimensional code generation device 2502, and a comparison device 2503 on the server side are connected to the bus 411 of the host server 103. The Web server device 405 is a device that provides an online banking service to the client computer 102. The secret information holding device 406 on the server side is a device that holds the secret information shared with the smartphone 101 in some way in advance. The random number generation device 407 is a device that generates a one-time password including a random character string or generates a random number. The transaction device 410 is a device that processes a transaction such as a transfer. The cryptographic processing device 2501 on the server side is a device that performs an encryption process and a keyed hash operation process, using the secret information held in the secret information holding device 406 on the server side. The two-dimensional code generation device 2502 is a device that generates a two-dimensional code from input data. The comparison device 2503 on the server side is a device that compares the information received by the Web server device 405 with the one-time password or random number generated by the random number generation device 407, and outputs a comparison result.

A signature calculation device 3401 on the server side is also connected to the bus 411 of the host server 103. The signature calculation device 3401 on the server side is a device that calculates a signature for the transfer information. The signature calculation device 3401 is an example of the server signature generation unit.

The secret information holding device 406 on the server side of the host server 103 holds a secret information management table 601 which stores a user ID 602 (602a, 602b, 603c, and so on) and corresponding secret information 603 (603a, 603b, 603c, and so on) for each user, as illustrated as an example in FIG. 6

The operation of an online transaction according to Embodiment 7 will now be described.

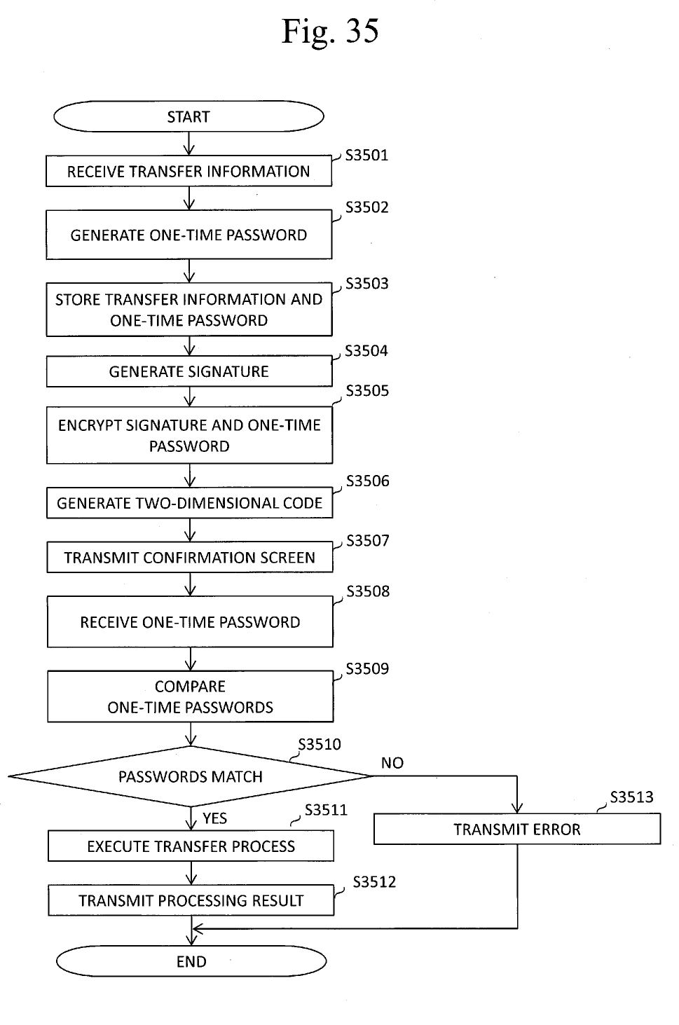

FIG. 35 is a flowchart illustrating a flow of the operation of the host server 103 according to Embodiment 7.

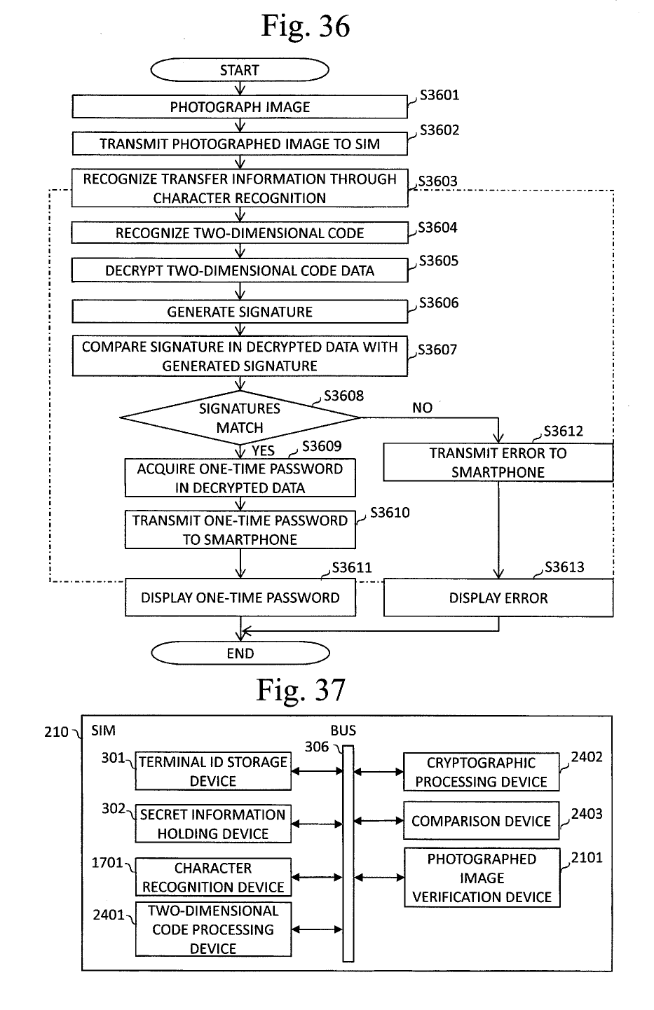

FIG. 36 is a flowchart illustrating a flow of the operation of the smartphone 101 and the SIM card 210 according to Embodiment 7.

Description will be given with reference also, as appropriate, to FIG. 26, FIG. 27, and FIG. 30 to FIG. 32 described in Embodiment 6.

Referring to FIG. 26, to start with, the SIM card 210 of the smartphone 101 and the host server 103 of the bank share secret information 701 (701a, 701b) in advance. The secret information 701a on the SIM card 210 side is held in the secret information holding device 302 on the user-terminal side of the SIM card 210, and the secret information 701b on the host server 103 side is stored in the secret information 603 (603a) in the secret information management table 601 held in the secret information holding device 406 on the server side of the host server 103.

Next, the user logs in to the online banking service of the host server 103 from the Web browsing device 507 of the client computer 102, and enters transfer information such as a transfer destination account number and a transfer amount on a screen for performing a transfer operation from the input/output interface 505 of the client computer 102 (S2701), and then transmits the transfer information to the Web server device 405 of the host server 103 (2601, S2702).

Next, the Web server device 405 of the host server 103 receives the transfer information from the client computer 102 (S3501), then generates a one-time password with the random number generation device 407 (S3502), and stores the received transfer information and the generated one-time password in a transfer information registration table 3001 held in the memory 402 or the like of the host server 103 (S3503). Then, the signature calculation device 3401 on the server side calculates a hash value of the transfer information to generate a signature (S3504). The cryptographic processing device 2501 on the server side encrypts the signature for the transfer information and the one-time password, using the secret information 603a (701b) held in the secret information management table 601 in the secret information holding device 406 on the server side (S3505), and the two-dimensional code generation device 2502 generates a two-dimensional code, using the encrypted data as input (S3506). The Web server device 405 transmits a confirmation screen 3101 indicating the transfer information (a transfer destination account number 1202 and a transfer amount 1203) and a two-dimensional code 3102 to the Web browsing device 507 of the client computer 102 (2602, S3507).

Next, the Web browsing device 507 of the client computer 102 receives the confirmation screen 3101 (S2703) and displays the confirmation screen 3101 on the display 506 (S2704).

Next, the user photographs the confirmation screen 3101 displayed on the display 506 of the client computer 102 with the camera device 1601 of the smartphone 101 (2603, S3601). The smartphone 101 transmits the photographed image to the SIM card 210 (2604, S3602).

The character recognition device 1701 of the SIM card 210 which has received the photographed image recognizes characters shown in the photographed image to acquire the transfer information (the transfer destination account number 1202 and the transfer amount 1203) (S3603). The two-dimensional code processing device 2401 recognizes the two-dimensional code 3102 shown in the photographed image to acquire data from the two-dimensional code 3102 (S3604). The cryptographic processing device 2402 on the user-terminal side decrypts the data acquired from the two-dimensional code 3102, using the secret information 701a held in the secret information holding device 302 on the user-terminal side, to acquire the signature for the transfer information and the one-time password (S3605).

Next, the signature calculation device 3301 on the user-terminal side calculates a hash value of the transfer information character-recognized by the character recognition device 1701 to generate a signature for the transfer information (S3606). The comparison device 2403 on the user-terminal side compares the signature calculated by the signature calculation device 3301 on the user-terminal side with the signature for the transfer information acquired by the cryptographic processing device 2402 on the user-terminal side to determine whether the signatures match (S3607, S3608). If the signatures match, the one-time password acquired by the cryptographic processing device 2402 on the user-terminal side (S3609) is transmitted to the smartphone 101 together with the transfer information (2605, S3610) and displayed by the display 208 of the smartphone 101 (S3611).

On the other hand, if the signatures do not match as a result of determination in S3608, an error notification is transmitted to the smartphone 101 (S3612), an error is displayed by the display 208 of the smartphone 101 (S3613), and the processing ends.

Next, the user checks the transfer information (the transfer destination account number 1302 and the transfer amount 1303) displayed on the display 208 of the smartphone 101, and enters the displayed one-time password 3202 into a one-time password input box 3103 on the confirmation screen 3101 from the input/output interface 505 of the client computer 102 (2606, S2705).

Next, the Web browsing device 507 of the client computer 102 transmits the one-time password entered by the user to the Web server device 405 of the host server 103 (2607, S2706).

Next, when the Web server device 405 of the host server 103 receives the one-time password (S3508), the comparison device 2503 on the server side retrieves the one-time password 3002 registered in the transfer information registration table 3001, and compares the retrieved one-time password with the received one-time password to determine whether the one-time passwords match (S3509, S3510). If the one-time passwords match, the transaction device 410 of the host server 103 executes a transfer process, based on the transfer information (the transfer destination account number 1103 and the transfer amount 1104) registered in the transfer information registration table 3001 (S3511), and the Web server device 405 transmits a processing result to the Web browsing device 507 of the client computer 102 (2608, S3512).

On the other hand, if the one-time passwords do not match as a result of determination in S3510, the Web server device 405 of the host server 103 transmits an error (2608, S3513).

Finally, the Web browsing device 507 of the client computer 102 receives the result (S2707), displays the result on the display 506 (S2708), and ends the processing.

As described above, a signature for transfer information is used. Thus, when the data size of transfer information is large, the size of data embedded in a two-dimensional code can be reduced. In addition, the information to be compared is only the signature, so that comparison on the user terminal is facilitated.

### Embodiment 8

In Embodiments 6 and 7 above, it is possible for sophisticated malware to tamper with an image photographed with a camera. This embodiment describes an embodiment which prevents tampering of an image by sophisticated malware.

In this embodiment, a hardware configuration of a client computer 102 is identical to that of FIG. 5 described in Embodiment 1. A hardware configuration of a smartphone 101 is identical to that of FIG. 20 described in Embodiment 4. A hardware configuration of a host server 103 is identical to that of FIG. 25 described in Embodiment 6.

FIG. 37 is a diagram illustrating a hardware configuration of a SIM card 210 according to Embodiment 8.

Referring to FIG. 37, a terminal ID storage device 301 for fulfilling regular functions of the SIM card 210 is connected to a bus 306.

In addition, as in Embodiment 6, a secret information holding device 302 on the user-terminal side, a character recognition device 1701, a two-dimensional code processing device 2401, a cryptographic processing device 2402 on the user-terminal side, and a comparison device 2403 on the user-terminal side are connected to the bus 306 of the SIM card 210. The secret information holding device 302 on the user-terminal side is a device that holds secret information shared with the host server 103 of a bank in some way in advance. The character recognition device 1701 is a device that recognizes characters shown in an image photographed with the camera device 1601 of the smartphone 101. The two-dimensional code processing device 2401 is a device that recognizes a two-dimensional code included in an image photographed with the camera device 1601 of the smartphone 101 to acquire data from the two-dimensional code. The cryptographic processing device 2402 on the user-terminal side is a device that performs an encryption process and a keyed hash operation process, using the secret information held in the secret information holding device 302 on the user-terminal side. The comparison device 2403 on the user-terminal side is a device that compares the transfer information character-recognized by the character recognition device 1701 with the transfer information obtained from data acquired by the two-dimensional code processing device 2401, and outputs a comparison result.

A photographed image verification device 2101 is also connected to the bus 306 of the SIM card 210. The photographed image verification device 2101 is a device that shares secret information with the photographed image tampering prevention device 2001 of the smartphone 101 in some way in advance, and using the secret information, verifies that photographed image data to which a signature such as a keyed hash value has been attached or which has been encrypted is legitimate. The photographed image verification device 2101 verifies that the photographed image is legitimate by using the secret information to generate a signature, such as a keyed hash value, for the image data and comparing the generated signature with the signature attached to the photographed image data for verification, or by using the secret information to decrypt the encrypted image data and checking that the encrypted image data has been decrypted correctly.

The operation of an online transaction according to Embodiment 8 will now be described.

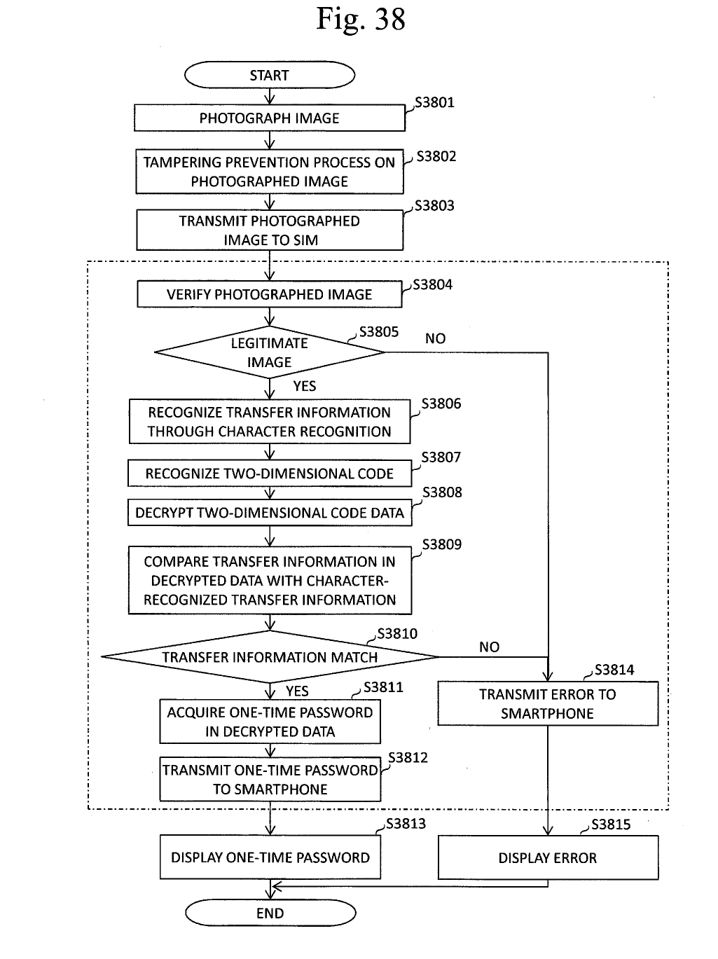

The operation is substantially the same as in Embodiment 6, except for the operation after the smartphone 101 photographs the confirmation screen 3101 (S2901) in FIG. 29 until S2903 in which the transfer information is recognized through character recognition. The operation after the smartphone 101 photographs the confirmation screen 3101 until the transfer information is recognized through character recognition will be described hereinafter with reference to FIG. 38.

FIG. 38 is a flowchart illustrating a flow of the operation of the smartphone 101 and the SIM card 210 according to Embodiment 8.

Referring to FIG. 38, when the smartphone 101 photographs an image with the camera device 1601 (S3801), the photographed image tampering prevention device 2001 of the smartphone 101 performs a tampering prevention process on the photographed image by attaching a signature or by encryption (S3802), and then transmits the photographed image to the SIM card 210 (S3803). The image device verification device 2101 of the SIM card 210 which has received the photographed image verifies the photographed image to determine whether it is a legitimate image (S3804, S3805).

If the photographed image is legitimate as a result of determination in S3805, the character recognition device 1701 recognizes the characters shown in the photographed image to acquire the transfer information (the transfer destination account number 1202 and the transfer amount 1203) (S3806). The operation thereafter of S3807 to S3815 is substantially the same as in Embodiment 3.

On the other hand, if the photographed image is not legitimate, an error is transmitted to the smartphone 101 (S3814), the error is displayed by the display 208 of the smartphone 101 (S3815), and the processing ends.

As described above, the photographed image tampering prevention device of the smartphone and the photographed image verification device of the SIM card share secret information in advance, and the secret information is used to detect tampering. Thus, even if the smartphone is infected with malware, tampering of a photographed image by the malware can be prevented. Therefore, an online transaction with enhanced security can be realized.

### Embodiment 9

In Embodiments 6 to 8 above, the display device (display) of the user terminal (smartphone) displays transaction information such as transfer information and a random number without performing special processing on the transaction information. Next, Embodiment 9 describes an embodiment in which a display device of a user terminal displays transaction information in accordance with a secret rule set by a user in advance. This embodiment corresponds to a case in which the display method of the user terminal described in Embodiment 2 is applied to Embodiments 6 and 8. This embodiment will be described assuming that the secret rule is that the color of displayed characters changes depending on a transfer amount range. However, the secret rule is not limited to this.

In this embodiment, a hardware configuration of a smartphone 101 which is a user terminal is identical to that of FIG. 16 described in Embodiment 3. A hardware configuration of a host server 103 is identical to that of FIG. 25 described in Embodiment 6. A hardware configuration of a client computer 102 is identical to that of FIG. 5 described in Embodiment 1.

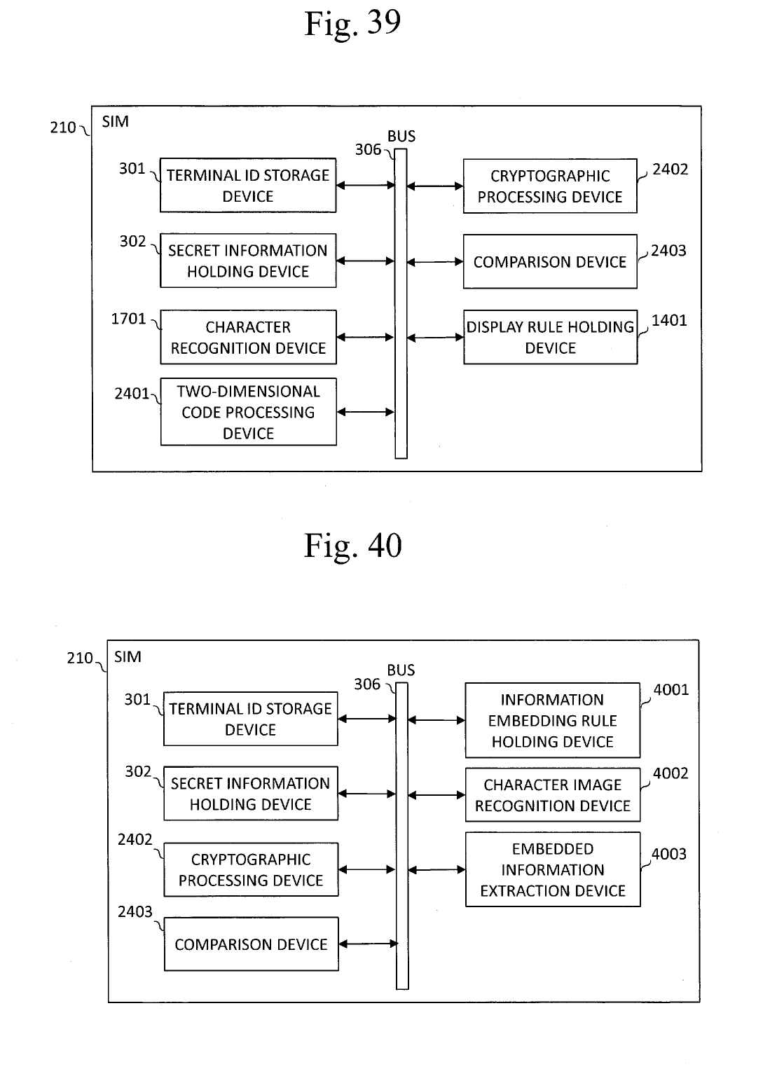

FIG. 39 is a diagram illustrating a hardware configuration of a SIM card 210 according to Embodiment 9.

Referring to FIG. 39, a terminal ID storage device 301 for fulfilling regular functions of the SIM card 210 is connected to a bus 306.

In addition, as in Embodiment 6, a secret information holding device 302 on the user-terminal side, a character recognition device 1701, a two-dimensional code processing device 2401, a cryptographic processing device 2402 on the user-terminal side, and a comparison device 2403 on the user-terminal side are connected to the bus 306 of the SIM card 210. The secret information holding device 302 on the user-terminal side is a device that holds secret information shared with the host server 103 of a bank in some way in advance. The character recognition device 1701 is a device that recognizes characters shown in an image photographed with the camera device 1601 of the smartphone 101. The two-dimensional code processing device 2401 is a device that recognizes a two-dimensional code included in an image photographed with the camera device 1601 of the smartphone 101 to acquire data from the two-dimensional code. The cryptographic processing device 2402 on the user-terminal side is a device that performs an encryption process and a keyed hash operation process, using the secret information held in the secret information holding device 302 on the user-terminal side. The comparison device 2403 on the user-terminal side is a device that compares the transfer information character-recognized by the character recognition device 1701 with the transfer information obtained from the data acquired by the two-dimensional code processing device 2401, and outputs a comparison result.

A display rule holding device 1401 is also connected to the bus 306 of the SIM card 210. The display rule holding device 1401 is a device that securely holds a display rule that defines a display method for the smartphone 101 when displaying transfer information and a one-time password on the display 208. The display rule is set by the user in some way in advance and is held in the display rule holding device 1401 as a display rule table 1501 as illustrated as an example in FIG. 15.

The operation of an online transaction according to Embodiment 9 will now be described.

The operation is the same as that of Embodiment 6 described with reference to FIG. 26 to FIG. 32, except for the operation of S2910 of FIG. 29 in which the transfer information (the transfer destination account number 1302 and the transfer amount 1303) and the one-time password 3202 of FIG. 32 is displayed by the display 208 of the smartphone 101.

When the display 208 of the smartphone 101 displays (the transfer destination account number 1302 and the transfer amount 1303) and the one-time password 3202, the display 208 acquires the display rule table 1501 from the display rule holding device 1401 of the SIM card 210, and changes a character color in accordance with the display rule table 1501. For example, if the transfer amount 1303 is ¥10,000, the display 208 changes the character color to brown in accordance with the display rule table 1501.

As described above, a display rule set by the user in advance is held in the SIM card into which malware cannot intrude, and the smartphone displays transaction information in accordance with the display rule. Thus, it is difficult for malware which has infected the smartphone to change the display without being noticed by the user. Therefore, an online transaction with enhanced security can be realized.

### Embodiment 10

In the Embodiments 6 to 9 above, transaction information (transfer information and a one-time password) is embedded in a two-dimensional code. This embodiment describes an embodiment in which transaction information (transfer information and a one-time password) is embedded in a character image representing the transaction information (transfer information). This embodiment will be described using an example in which a one-time password is used for authentication of a transaction. However, substantially the same processing can also be performed using a keyed hash operation, a random number, and a signature, and the one-time password is a non-limiting example.

In this embodiment, a hardware configuration of a smartphone 101 which is a user terminal is identical to that of FIG. 16 described in Embodiment 3. A hardware configuration of a client computer 102 is identical to that of FIG. 5 described in Embodiment 1.

FIG. 40 is a diagram illustrating a hardware configuration of a SIM card 210 according to Embodiment 10.

Referring to FIG. 40, a terminal ID storage device 301 for fulfilling regular functions of the SIM card 210 is connected to a bus 306.

In addition, a secret information holding device 302 on the user-terminal side, an information embedding rule holding device 4001 on the user-terminal side, a character image recognition device 4002, an embedded information extraction device 4003, a cryptographic processing device 2402 on the user-terminal side, and a comparison device 2403 on the user-terminal side are connected to the bus 306 of the SIM card 210. The information embedding rule holding device 4001 is an example of an information embedding rule storage unit. The secret information holding device 302 on the user-terminal side is a device that holds secret information shared with a host server 103 of a bank in some way in advance. The information embedding rule holding device 4001 on the user-terminal side is a device that holds an information embedding rule 4701 shared with the host server 103 of the bank in some way in advance. The character image recognition device 4002 is a device that recognizes characters represented by a character image included in an image photographed with the camera device 1601 of the smartphone 101. The embedded information extraction device 4003 is a device that extracts embedded information data which is information embedded in a character image photographed with the camera device 1601 of the smartphone 101. The cryptographic processing device 2402 on the user-terminal side is a device that performs an encryption process and a keyed hash operation process, using the secret information held in the secret information holding device 302 on the user-terminal side. The comparison device 2403 on the user-terminal side is a device that compares the transfer information recognized by the character image recognition device 4002 with the transfer information obtained from the embedded information data extracted by the embedded information extraction device 4003, and outputs a comparison result. The information embedding rule holding device 4001 is an example of the information embedding rule storage unit, the character image recognition device 4002 is an example of the verification unit, and the embedded information extraction device 4003 is an example of the information extraction unit.

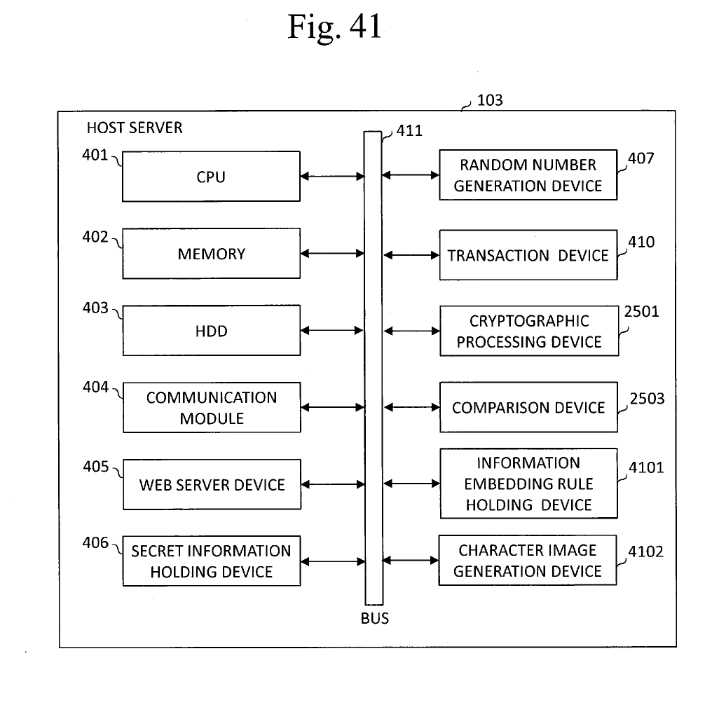

FIG. 41 is a diagram illustrating a hardware configuration of the host server 103 according to Embodiment 10.

Referring to FIG. 41, a CPU 401, a memory 402, a hard disk drive (HDD) 403, and a communication module 404 are connected to a bus 411.

In addition, a Web server device 405 which is an online transaction server, a secret information holding device 406 on the server side, a random number generation device 407, a transaction device 410, an information embedding rule holding device 4101 on the server side, a character image generation device 4102, a cryptographic processing device 2501 on the server side, and a comparison device 2503 on the server side are connected to the bus 411 of the host server 103. The Web server device 405 is a device that provides an online banking service to the client computer 102. The secret information holding device 406 on the server side is a device that holds the secret information shared with the smartphone 101 in some way in advance. The random number generation device 407 is a device that generates a one-time password including a random character string, or generates a random number. The transaction device 410 is a device that performs a transaction such as a transfer. The information embedding rule holding device 4101 on the server side is a device that holds the information embedding rule 4701 shared with the smartphone 101 in some way in advance. The character image generation device 4102 is a device that generates a character image in which embedded information data is embedded, in accordance with the information embedding rule 4701 held in the information embedding rule holding device 4101 on the server side. The cryptographic processing device 2501 on the server side is a device that performs an encryption process and a keyed hash operation process, using the secret information held in the secret information holding device 406 on the server side. The comparison device 2503 on the server side is a device that compares the information received by the Web server device 405 with the one-time password or random number generated by the random number generation device 407, and outputs a comparison result.

The secret information holding device 406 on the server side holds a secret information management table 601 which stores a user ID 602 (602a, 602b, 603c, and so on) and corresponding secret information 603 (603a, 603b, 603c, and so on) for each user, as illustrated as an example in FIG. 6.

The information embedding rule holding device 4101 on the server side of the host server 103 holds an information embedding rule table 4801.

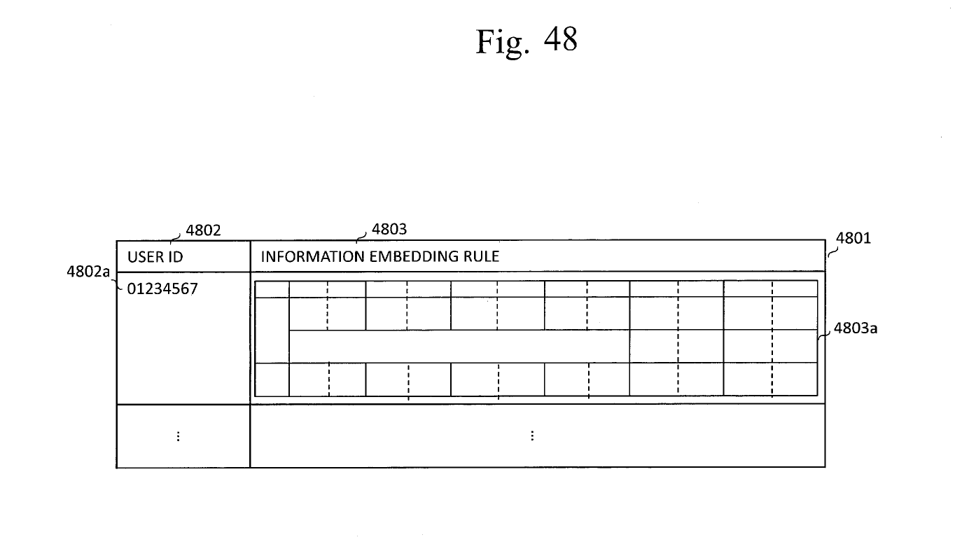

FIG. 48 is a diagram illustrating an example of the information embedding rule table 4801.

The information embedding rule table 4801 which stores a user ID 4802 (4802a and so on) and a corresponding information embedding rule 4803 (4803a and so on) ⋅ 4071 for each user is held, as illustrated as an example in FIG. 48. In this embodiment, the information embedding rule 4803 (4803a and so on). 4071 which is different for each user is held as the information embedding rule table 4801. However, the information embedding rule 4701 which is the same for all users may be held.

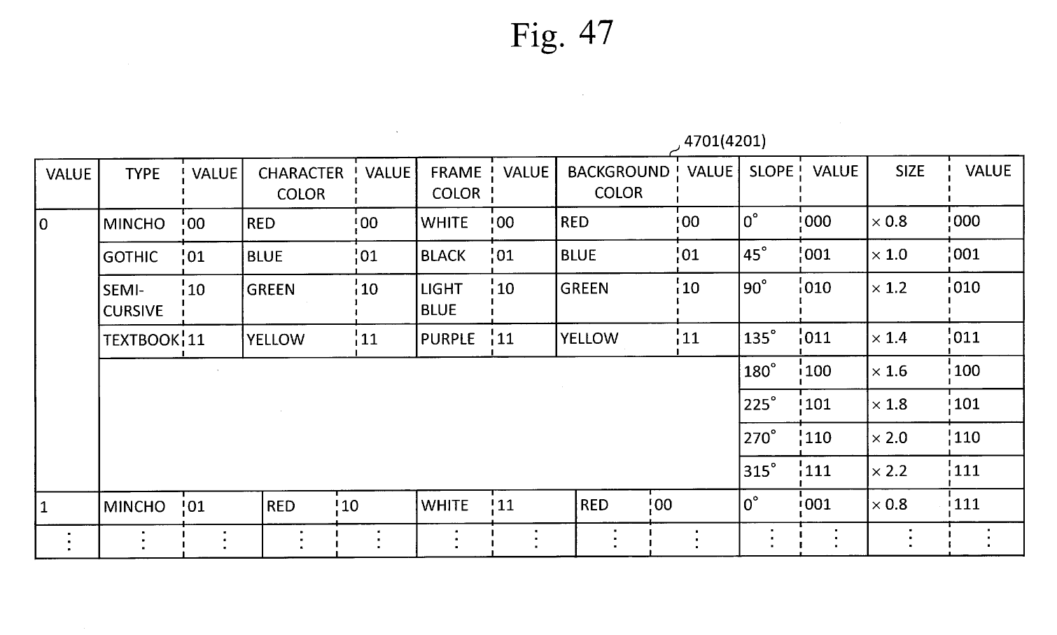

FIG. 47 is a diagram illustrating an example of the information embedding rule 4701 shared by the smartphone 101 and the host server 103 of the bank.

In FIG. 47, even for the same character, a different bit string is shown for each type (font) of the character, for each color of the character, for each color of the character frame, for each background color of the character, for each slope of the character, and for each size of the character. For example, in FIG. 47, when the type (font) of the character of a numerical value “0” is Mincho type, the color of the character is red, the color of the character frame is white, the background color of the character is red, the slope is 0°, and the size is 0.8 times the reference character, information embedded in the character image signifies a bit string 00 00 00 00 000 000.

In this embodiment, as mentioned above, the information embedding rule 4701 is different for each user. Thus, even when the type (font) of the character “0” is Mincho type, the color of the character is red, the color of the character frame is white, the background color of the character is red, the slope is 0°, and the size is 0.8 times the reference character, this results in a different bit string for each user. Further, in this embodiment, the order in which the bit string is arranged is in order of the type (font) of the character, the color of the character, the color of the character frame, the background color of the character, the slope of the character, and the size of the character. However, the order in which the bit string is arranged may be different for each user. In this embodiment, the bit string corresponding to the type (font) of the character, the color of the character, the color of the character frame, the background color of the character, the slope of the character, and the size of the character is different for each character. However, the corresponding bit string may be the same for all characters.

The operation of an online transaction according to Embodiment 10 will now be described.

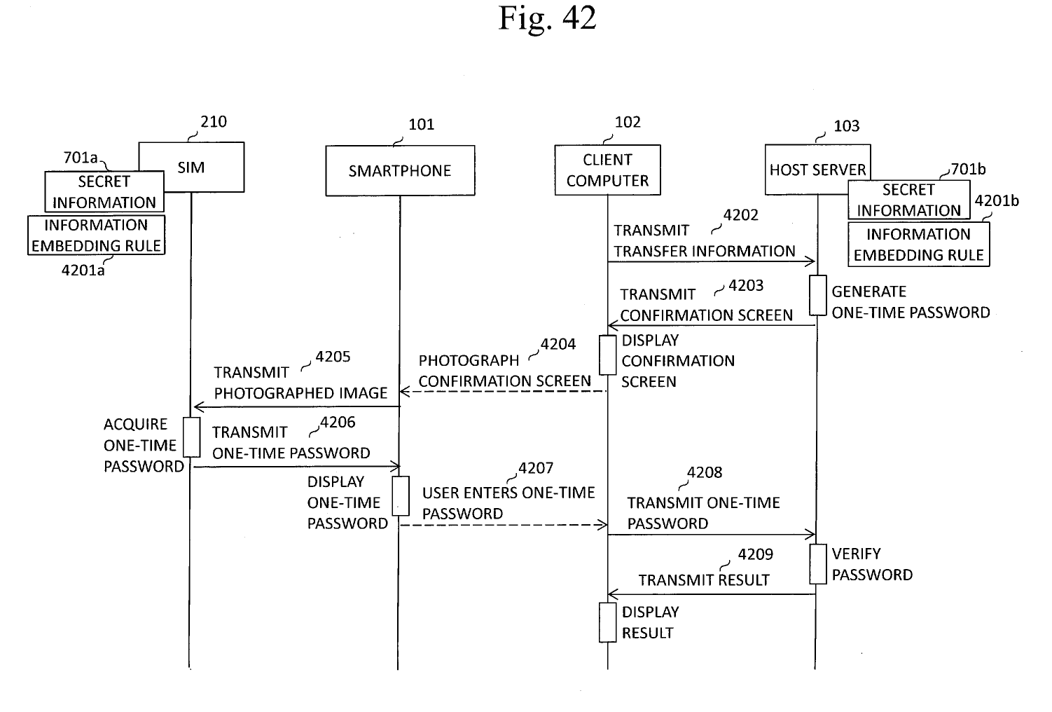

FIG. 42 is a diagram illustrating an operational sequence of the online transaction according to Embodiment 10.

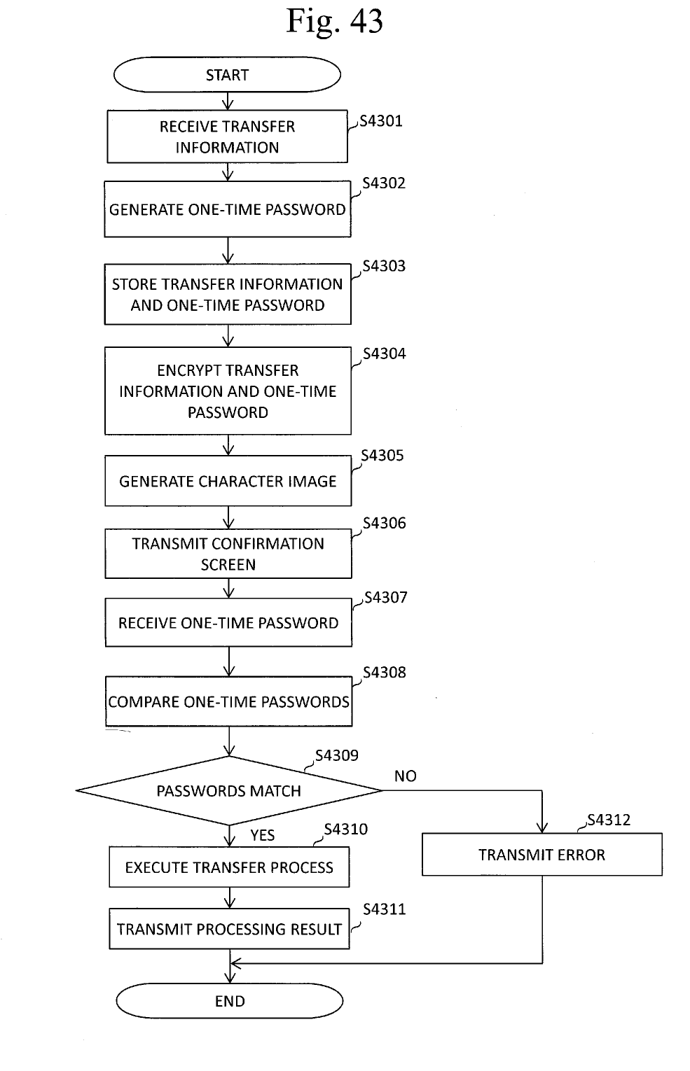

FIG. 43 is a flowchart illustrating the operation of the host server 103 according to Embodiment 10.

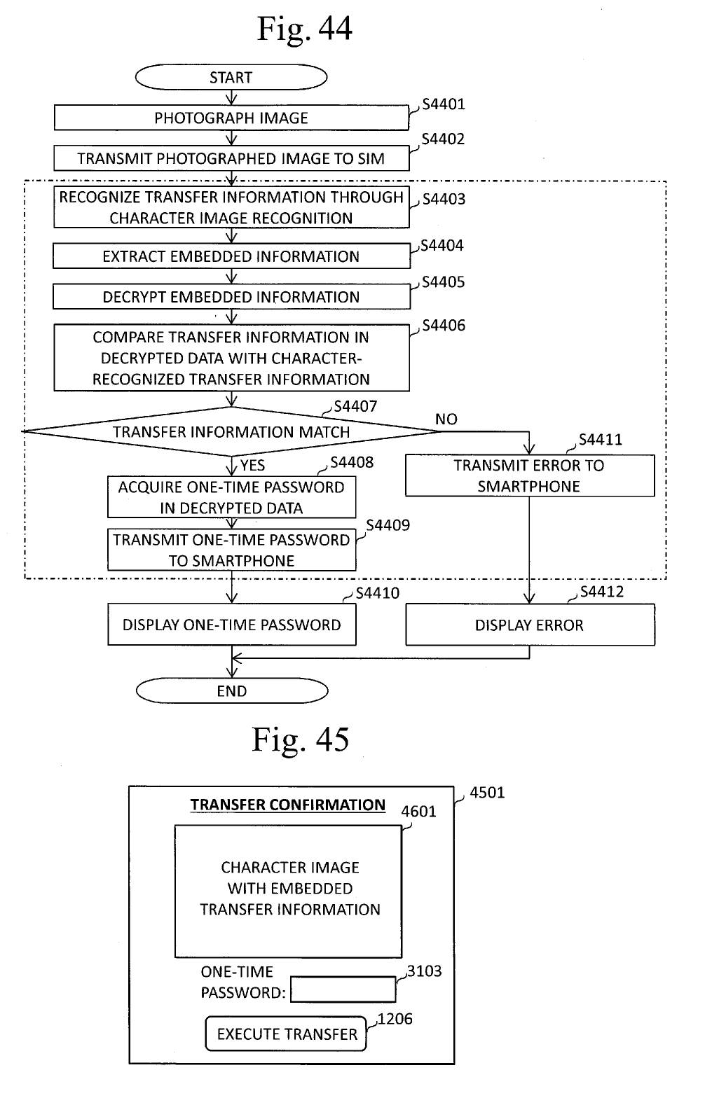

FIG. 44 is a flowchart illustrating a flow of the operation of the smartphone 101 and the SIM card 210 according to Embodiment 10.

FIG. 45 is a diagram illustrating an example of a confirmation screen 4501 for a transfer that the host server 103 transmits to the client computer 102.

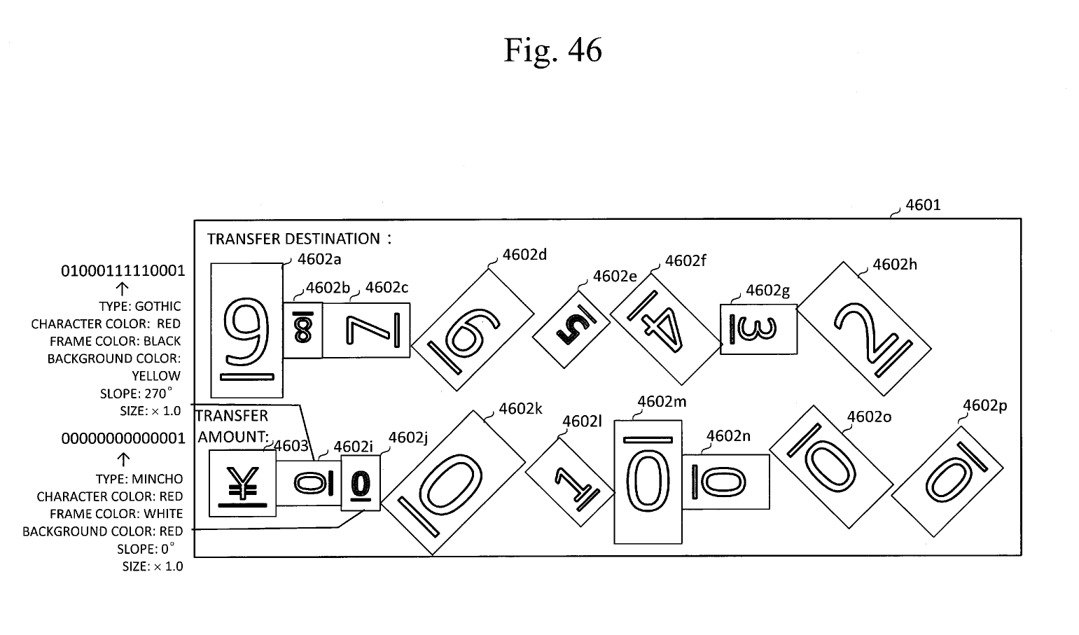

FIG. 46 is a diagram illustrating an example of a character image 4601 in which the transfer information of the confirmation screen 4501 is embedded.

Referring to FIG. 42, the SIM card 210 of the smartphone 101 and the host server 103 of the bank share secret information 701 (701a, 701b) and an information embedding rule 4201 (4201a, 4201b) in advance. The secret information 701a on the SIM card 210 side is held in the secret information holding device 302 on the user-terminal side of the SIM card 210, and the secret information 701b on the host server 103 side is stored in the secret information 603 (603a) in the secret information management table 601 held by the secret information holding device 406 on the server side of the host server 103. The information embedding rule 4201a of the SIM card 210 side is stored in the information embedding rule holding device 4001 on the user-terminal side of the SIM card 210, and the information embedding rule 4201b on the host server 103 side is stored in the information embedding rule 4803 (4803a) in the information embedding rule table 4801 held in the information embedding rule holding device 4101 on the server side of the host server 103.

Next, the user logs in to the online banking service from the Web browsing device 507 of the client computer 102, enters transfer information such as a transfer destination account number and a transfer amount on a screen for performing a transfer operation from the input/output interface 505 of the client computer 102, and then transmits the transfer information to the Web server device 405 of the host server 103 (4202).

Next, the Web server device 405 of the host server 103 receives the transfer information from the client computer 102 (S4301), then generates a one-time password with the random number generation device 407 (S4302), and stores the received transfer information and the generated one-time password in a transfer information registration table 3001 held in the memory 402 or the like of the host server 103 (S4303). Then, the cryptographic processing device 2501 on the server side encrypts the transfer information and the one-time password, using the secret information 603a (701b) held in the secret information management table 601 in the secret information holding device 406 on the server side (S4304), and the character image generation device 4102 creates the character image 4601 indicating the transfer information, using the encrypted data as input and in accordance with the information embedding rule 4201b ⋅ 4803 ⋅ 4701 held in the information embedding rule table 4801 (S4305). The Web server device 405 transmits the confirmation screen 4501 including the character image 4601 to the Web browsing device 507 of the client computer 102 (4203, S4306).

In the character image 4601 generated by the character image generation device 4102, encrypted data is embedded in each character image 4602a to 4602p representing the transfer information. A reference character image 4603 is also embedded in the character image 4601, and is used for purposes such as determining the size of each character image 4602a to 4602p. For example, for the character image 4602i, the type (font) is Gothic type, the color of the character is red, the color of the character frame is black, the background color is yellow, the slope is 270°, and the size of the character is the same as (1.0 times) the reference character image 4603, so that information of a bit string 01 00 01 11 110 001 is embedded according to the information embedding rule 4701. In this embodiment, “¥” is used as the reference character image 4603. However, “¥” is a non-limiting example and information may be embedded in “¥”.

Next, the Web browsing device 507 of the client computer 102 receives the confirmation screen 4501 and displays the confirmation screen 4501 on the display 506.

Next, the user photographs the confirmation screen 4501 displayed on the display 506 of the client computer 102 with the camera device 1601 of the smartphone 101 (4204, S4401). The smartphone 101 transmits the photographed image to the SIM card 210 (4205, S4402).

Next, the character image recognition device 4002 of the SIM card 210 which has received the photographed image recognizes characters shown in the character image 4601 on the confirmation screen 4501 to acquire the transfer information (the destination account number 4602a to 4602h and the transfer amount 4602i to 4602p) (S4403). The embedded information extraction device 4003 extracts the embedded information embedded in the character image 4601, using the information embedding rule 4201a-4701 held in the information embedding rule holding device 4001 on the user-terminal side (S4404). The cryptographic processing device 2402 on the user-terminal side decrypts the embedded information acquired by the embedded information extraction device 4003, using the secret information 701a held in the secret information holding device 302 on the user-terminal side to acquire the transfer information and the one-time password (S4405).

Next, the comparison device 2403 on the user-terminal side compares the transfer information acquired by the character image recognition device 4002 with the transfer information acquired by the cryptographic processing device 2402 on the user-terminal side to determine whether these pieces of the transfer information match (S4406, S4407). If the pieces of the transfer information match, the one-time password acquired by the cryptographic processing device 2402 on the user-terminal side (S4408) is transmitted to the smartphone 101 together with the transfer information (4206, S4409) and displayed by the display 208 of the smartphone 101 (S4410).

On the other hand, if the pieces of the transfer information do not match as a result of determination in S4407, an error notification is transmitted to the smartphone 101 (S4411), and the error notification is displayed by the display 208 of the smartphone 101 (S4412), and the processing ends.

Next, the user checks the transfer information (the transfer destination account number 1302 and the transfer amount 1303) displayed on the display 208 of the smartphone 101, and enters a displayed one-time password 3202 into a one-time password input box 3103 on the confirmation screen 4501 from the input/output interface 505 of the client computer 102 (4207).

Next, the Web browsing device 507 of the client computer 102 transmits the one-time password entered by the user to the Web server device 405 of the host server 103 (4208).

Next, when the Web server device 405 of the host server 103 receives the one-time password (S4307), the comparison device 2503 on the server side retrieves a one-time password 3002 registered in the transfer information registration table 3001, and compares the retrieved one-time password with the received one-time password to determine whether the one-time passwords match (S4308, S4309). If the one-time passwords match, the transaction device 410 of the host server 103 executes a transfer process, based on the transfer information (the transfer destination account number 1103 and the transfer amount 1104) registered in the transfer information registration table 3001 (S4310), and the Web server device 405 transmits a processing result to the Web browsing device 507 of the client computer 102 (4209, S4311).

On the other hand, if the one-time passwords do not match as a result of determination in S4309, the Web server device 405 of the host server 103 transmits an error (4209, S4312).

Finally, the Web browsing device 507 of the client computer 102 receives the result, displays the result on the display 506, and ends the processing.

As described above, transaction information is embedded in a character image representing the transaction information, and the transaction information which has been character-recognized is compared with the transaction information embedded in the character image. This makes it more difficult to tamper with the transaction information. Thus, it is possible to prevent a malicious action from being performed even if malware performing a MITB attack which has infected a client computer and malware which has infected a user terminal collaborate with each other. Further, the SIM card is used. Thus, since it is impossible for malware to infect the SIM card, it is possible to prevent the malware which has infected the user terminal from performing a malicious action on the SIM card. Therefore, an online transaction with guaranteed security and credibility can be realized.

### Embodiment 11

In Embodiment 10 above, the host server transmits transaction information (transfer information) by embedding the transaction information as it is in a character image without attaching a signature to the transaction information, and the user terminal compares the transaction information. This embodiment describes an embodiment in which a host server transmits a signature for transaction information (transfer information) by embedding the signature in a character image, and a user terminal compares the signature. This embodiment will be described using an example in which a one-time password is used. However, substantially the same processing can also be performed using a keyed hash operation, a random number, and a signature, and the one-time password is a non-limiting example. In this embodiment, a signature is attached using a hash operation. However, the method for attaching a signature is not limited to the hash operation.

In this embodiment, a hardware configuration of a smartphone 101 which is a user terminal is identical to that of FIG. 16 described in Embodiment 3. A hardware configuration of a client computer 102 is identical to that of FIG. 5 described in Embodiment 1.

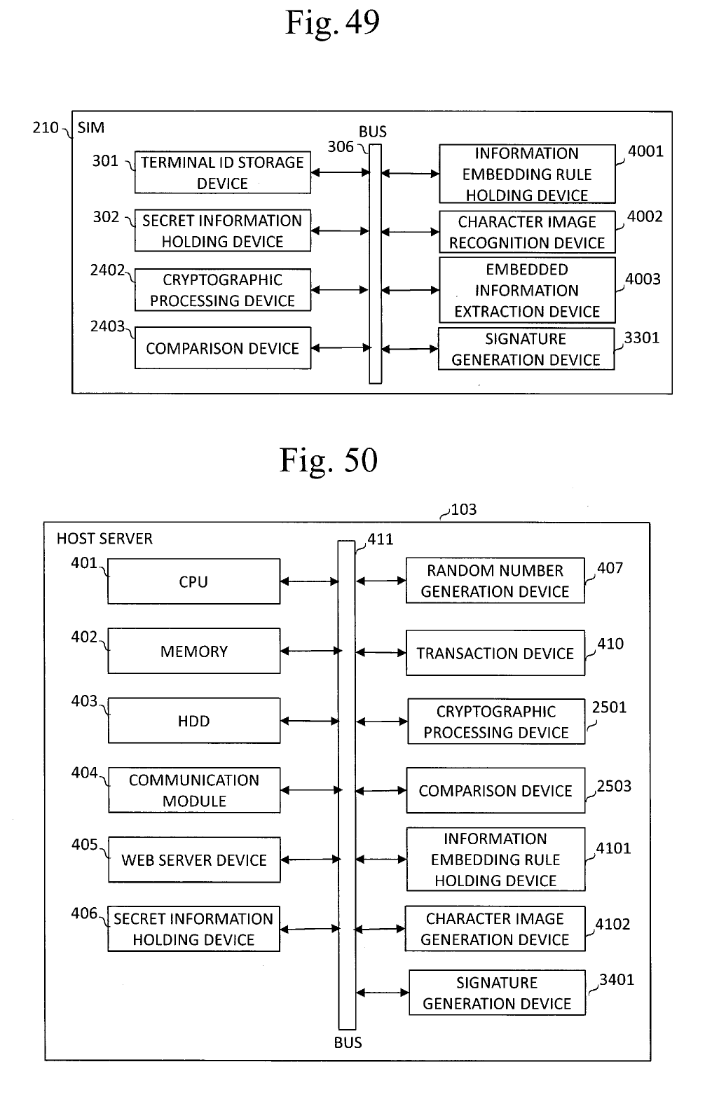

FIG. 49 is a diagram illustrating a hardware configuration of a SIM card 210 according to Embodiment 11.

Referring to FIG. 49, a terminal ID storage device 301 for fulfilling regular functions of the SIM card 210 is connected to a bus 306.

In addition, as in Embodiment 10, a secret information holding device 302 on the user-terminal side, an information embedding rule holding device 4001 on the user-terminal side, a character image recognition device 4002, an embedded information extraction device 4003, a cryptographic processing device 2402 on the user-terminal side, and a comparison device 2403 on the user-terminal side are connected to the bus 306 of the SIM card 210. The secret information holding device 302 on the user-terminal side is a device that holds secret information shared with a host server 103 of a bank in some way in advance. The information embedding rule holding device 4001 on the user-terminal side is a device that holds an information embedding rule 4701 shared with the host server 103 of the bank in some way in advance. The character image recognition device 4002 is a device that recognizes characters represented by a character image included in an image photographed with the camera device 1601 of the smartphone 101. The embedded information extraction device 4003 is a device that extracts embedded information data which is information embedded in a character image photographed with the camera device 1601 of the smartphone 101. The cryptographic processing device 2402 on the user-terminal side is a device that performs an encryption process and a keyed hash operation process, using the secret information held in the secret information holding device 302 on the user-terminal side. The signature calculation device 3301 on the user-terminal side is a device that calculates a signature for transfer information character-recognized by the character recognition device 1701. The comparison device 2403 on the user-terminal side is a device that compares the signature calculated by the signature calculation device 3301 for the transfer information character-recognized by the character image recognition device 4002 with the signature for the transfer information obtained from the embedded information data extracted by the embedded information extraction device 4003, and outputs a comparison result.

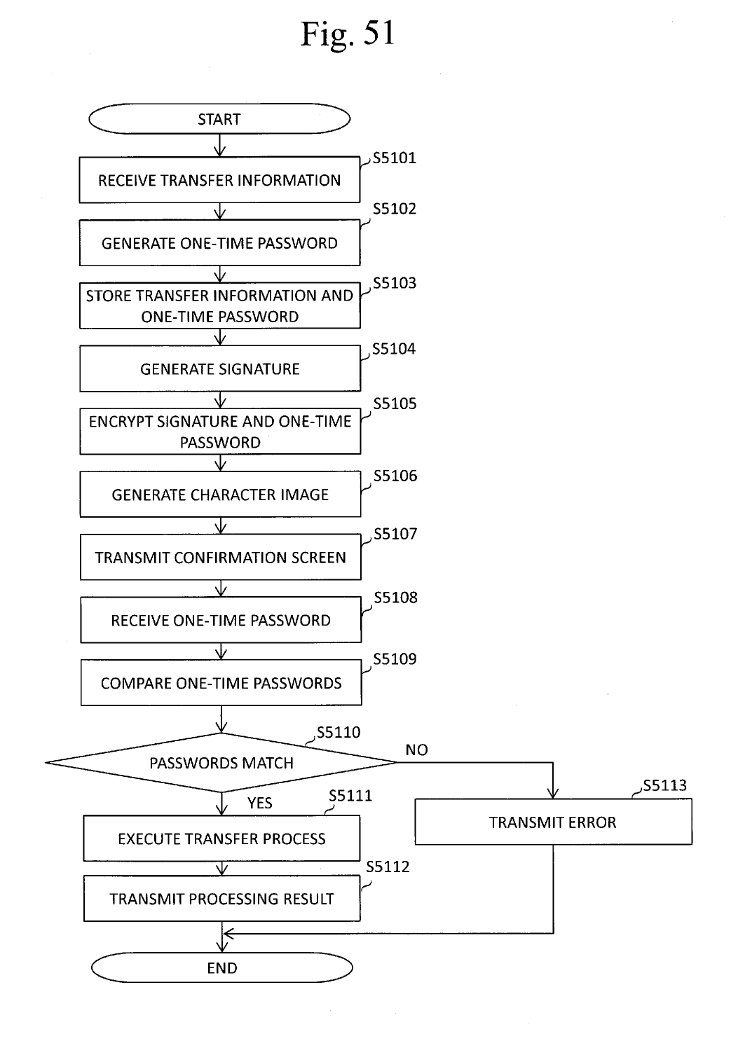

FIG. 50 is a diagram illustrating a hardware configuration of the host server 103 according to Embodiment 11.

Referring to FIG. 50, a CPU 401, a memory 402, a hard disk drive (HDD) 403, and a communication module 404 are connected to a bus 411.

In addition, as in Embodiment 10, a Web server device 405 which is an online transaction server, a secret information holding device 406 on the server side, a random number generation device 407, a transaction device 410, an information embedding rule holding device 4101 on the server side, a character image generation device 4102, a cryptographic processing device 2501 on the server side, and a comparison device 2503 on the server side are connected to the bus 411 of the host server 103. The Web server device 405 is a device that provides an online banking service to the client computer 102. The secret information holding device 406 on the server side is a device that holds the secret information shared with the smartphone 101 in some way in advance. The random number generation device 407 is a device that generates a one-time password including a random character string, or generates a random number. The transaction device 410 is a device that processes a transaction such as a transfer. The information embedding rule holding device 4101 on the server side is a device that holds the information embedding rule 4701 shared with the smartphone 101 in some way in advance. The character image generation device 4102 is a device that generates a character image in which embedded information data is embedded, in accordance with the information embedding rule 4701 held in the information embedding rule holding device 4101 on the server side. The cryptographic processing device 2501 on the server side is a device that performs an encryption process and a keyed hash operation process, using the secret information held in the secret information holding device 406 on the server side. The comparison device 2503 on the server side is a device that compares the information received by the Web server device 405 with the one-time password or random number generated by the random number generation device 407, and outputs a comparison result.

A signature calculation device 3401 on the server side is also connected to the bus 411 of the host server 103. The signature calculation device 3401 on the server side is a device that calculates a signature for the transfer information.

The secret information holding device 406 on the server side of the host server 103 holds a secret information management table 601 which stores a user ID 602 (602a, 602b, 603c, and so on) and corresponding secret information 603 (603a, 603b, 603c, and so on) for each user, as illustrated as an example in FIG. 6.

The information embedding rule holding device 4101 on the server side of the host server 103 holds an information embedding rule table 4801 which stores a user ID 4802 (4802a and so on) and a corresponding information embedding rule 4803 (4803a and so on) ⋅ 4701 for each user, as illustrated as an example in FIG. 47 and FIG. 48. In this embodiment, the information embedding rule 4803 (4803a and so on) ⋅ 4701 which is different for each user is held as the information embedding rule table 4801. However, the information embedding rule 4701 which is the same for all users may be held.

The operation of an online transaction according to Embodiment 11 will now be described.

FIG. 51 is a flowchart illustrating a flow of the operation of the host server 103 according to Embodiment 11.

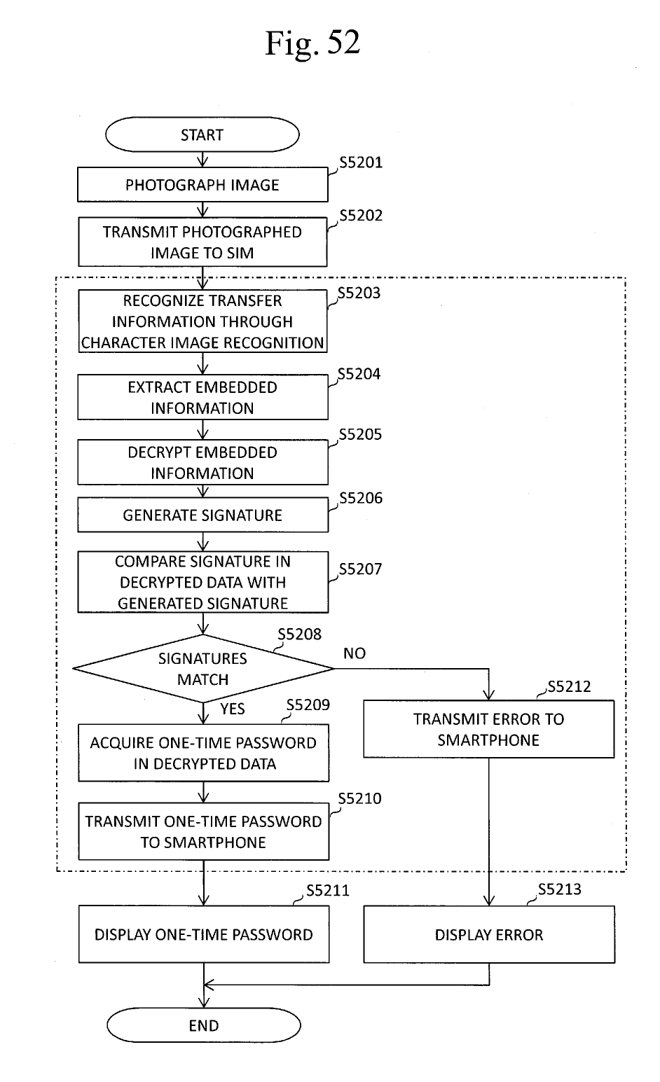

FIG. 52 is a flowchart illustrating a flow of the operation of the smartphone 101 and the SIM card 210 according to Embodiment 11.

An operational sequence of the online transaction according to Embodiment 11 will be described hereinafter with reference to FIG. 42.

Referring to FIG. 42, the SIM card 210 of the smartphone 101 and the host server 103 of the bank share secret information 701 (701a, 701b) and an information embedding rule 4201 (4201a, 4201b) in advance. The secret information 701a on the SIM card 210 side is held by the secret information holding device 302 on the user-terminal side of the SIM card 210, and the secret information 701b on the host server 103 side is stored in the secret information 603 (603a) in the secret information management table 601 held by the secret information holding device 406 on the server side of the host server 103. The information embedding rule 4201a on the SIM card 210 side is saved in the information embedding rule holding device 4001 on the user-terminal side of the SIM card 210, and the information embedding rule 4201b on the host server 103 side is stored in the information embedding rule 4803 (4803a) in the information embedding rule table 4801 held by the information embedding rule holding device 4101 on the server side of the host server 103.

Next, the user logs in to the online banking service from the Web browsing device 507 of the client computer 102, enters transfer information such as a transfer destination account number and a transfer amount on a screen for performing a transfer operation from the input/output interface 505 of the client computer 102, and then transmits the transfer information to the Web server device 405 of the host server 103 (4202).

Next, the Web server device 405 of the host server 103 receives the transfer information from the client computer 102 (S5101), then generates a one-time password with the random number generation device 407 (S5102), and stores the received transfer information and the generated one-time password in a transfer information registration table 3001 held in the memory 402 or the like of the host server 103 (S5103). Then, the signature calculation device 3401 on the server side calculates a hash value of the transfer information to generate a signature (S5104). The cryptographic processing device 2501 on the server side encrypts the signature for the transfer information and the one-time password, using the secret information 603a (701b) held in the secret information management table 601 of the secret information holding device 406 on the server side (S5105). The character image generation device 4102 creates a character image 4601 indicating the transfer information, using the encrypted data as input and in accordance with the information embedding rule 4201b ⋅ 4803 ⋅ 4701 held in the information embedding rule table 4801 (S5106). The Web server device 405 transmits the confirmation screen 4501 including the character image 4601 to the Web browsing device 507 of the client computer 102 (4203, S5107).

Next, the Web browsing device 507 of the client computer 102 receives the confirmation screen 4501 and displays the confirmation screen 4501 on the display 506.

Next, the user photographs the confirmation screen 4501 displayed on the display 506 of the client computer 102 with the camera device 1601 of the smartphone 101 (4204, S5201). The smartphone 101 transmits the photographed image to the SIM card 210 (4205, S5202).

Next, the character image recognition device 4002 of the SIM card 210 which has received the photographed image recognizes the characters shown in the character image 4601 on the confirmation screen 4501 to acquire the transfer information (a destination account number 4602a to 4602h and a transfer amount 4602i to 4602p) (S5203). The embedded information extraction device 4003 extracts embedded information embedded in the character image 4601, using the information embedding rule 4201a ⋅ 4701 held in the information embedding rule holding device 4001 on the user-terminal side (S5204). The cryptographic processing device 2402 on the user-terminal side decrypts the embedded information acquired by the embedded information extraction device 4003, using the secret information 701a held in the secret information holding device 302 on the user-terminal side to acquire the signature for the transfer information and the one-time password (S5205).

Next, the signature calculation device 3301 on the user-terminal side calculates a hash value of the transfer information acquired by the character image recognition device 4002 to generate a signature for the transfer information (S5206).

Next, the comparison device 2403 on the user-terminal side compares the signature calculated by the signature calculation device 3301 on the user-terminal side with the signature for the transfer information acquired by the cryptographic processing device 2402 on the user-terminal side to determine whether the signatures match (S5207, S5208). If the signatures match, the one-time password acquired by the cryptographic processing device 2402 on the user-terminal side (S5209) is transmitted to the smartphone 101 together with the transfer information (4206, S5210) and displayed by the display 208 of the smartphone 101 (S5211).

On the other hand, if the signatures do not match as a result of determination in S5208, an error notification is transmitted to the smartphone 101 (S5212), and the error notification is displayed by the display 208 of the smartphone 101 (S5213), and the processing ends.

Next, the user checks the transfer information (the transfer destination account number 1302 and the transfer amount 1303) displayed on the display 208 of the smartphone 101, and enters a displayed one-time password 3202 into a one-time password input box 3103 on the confirmation screen 4501 from the input/output interface 505 of the client computer 102 (4207).

Next, the Web browsing device 507 of the client computer 102 transmits the one-time password entered by the user to the Web server device 405 of the host server 103 (4208).

Next, when the Web server device 405 of the host server 103 receives the one-time password (S5107), the comparison device 2503 on the server side retrieves a one-time password 3002 registered in the transfer information registration table 3001, and compares the retrieved one-time password and the received password to determine whether the one-time passwords match (S5109, S5110). If the one-time passwords match, the transaction device 410 of the host server 103 executes a transfer process, based on the transfer information (the transfer destination account number 1103 and the transfer amount 1104) registered in the transfer information registration table 3001 (S5111), and the Web server device 405 transmits a processing result to the Web browsing device 507 of the client computer 102 (4209, S5112).

On the other hand, if the one-time passwords do not match as a result of determination in S5110, the Web server device 405 of the host server 103 transmits an error (4209, S5113).

Finally, the Web browsing device 507 of the client computer 102 receives the result, displays the result on the display 506, and ends the processing.

As described above, a signature for transfer information is used. Thus, when the data size of transfer information is large, the size of data embedded in a character image can be reduced. In addition, the information to be compared is only the signature, so that comparison on the user terminal is facilitated.

### Embodiment 12

In Embodiments 10 and 11 above, it is possible for sophisticated malware to tamper with an image photographed with a camera. This embodiment describes an embodiment which prevents tampering by sophisticated malware.

In this embodiment, a hardware configuration of a host server 103 is identical to that of FIG. 41 described in Embodiment 10. A hardware configuration of a client computer 102 is identical to that of FIG. 5 described in Embodiment 1. A hardware configuration of a smartphone 101 is identical to that of FIG. 20 described in Embodiment 4.

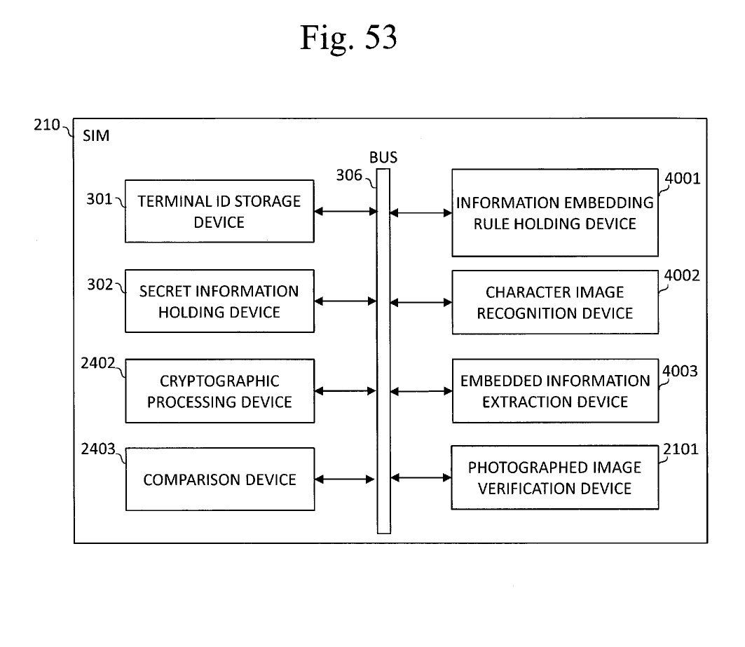

FIG. 53 is a diagram illustrating a hardware configuration of a SIM card 210 according to Embodiment 12.

Referring to FIG. 53, a terminal ID storage device 301 for fulfilling regular functions of the SIM card 210 is connected to a bus 306.

In addition, as in Embodiment 10, a secret information holding device 302 on the user-terminal side, an information embedding rule holding device 4001 on the user-terminal side, a character image recognition device 4002, an embedded information extraction device 4003, a cryptographic processing device 2402 on the user-terminal side, and a comparison device 2403 on the user-terminal side are connected to the bus 306 of the SIM card 210. The secret information holding device 302 on the user-terminal side is a device that holds secret information shared with the host server 103 of a bank in some way in advance. The information embedding rule holding device 4001 on the user-terminal side is a device that holds an information embedding rule 4701 shared with the host server 103 of the bank in some way in advance. The character image recognition device 4002 is a device that recognizes characters represented by a character image included in an image photographed with the camera device 1601 of the smartphone 101. The embedded information extraction device 4003 is a device that extracts embedded information data which is information embedded in a character image photographed with the camera device 1601 of the smartphone 101. The cryptographic processing device 2402 on the user-terminal side is a device that performs an encryption process and a keyed hash operation process, using the secret information held in the secret information holding device 302 on the user-terminal side. The comparison device 2403 on the user-terminal side is a device that compares the transfer information recognized by the character image recognition device 4002 with the transfer information obtained from the embedded information data extracted by the embedded information extraction device 4003, and outputs a comparison result.

A photographed image verification device 2101 is also connected to the bus 306 of the SIM card 210. The photographed image verification device 2101 is a device that shares secret information with the photographed image tampering prevention device 2001 of the smartphone 101 in some way in advance, and using the secret information, verifies that photographed image data which has been given a signature such as a keyed hash value or which has been encrypted is legitimate. The photographed image verification device 2101 verifies that the photographed image is legitimate by using the secret information to generate a signature, such as a keyed hash value, for the image data and comparing the generated signature with the signature attached to the photographed image data for verification, or by using the secret information to decrypt the encrypted image data and checking that the encrypted image data has been decrypted correctly.

The operation of an online transaction according to Embodiment 12 will now be described.

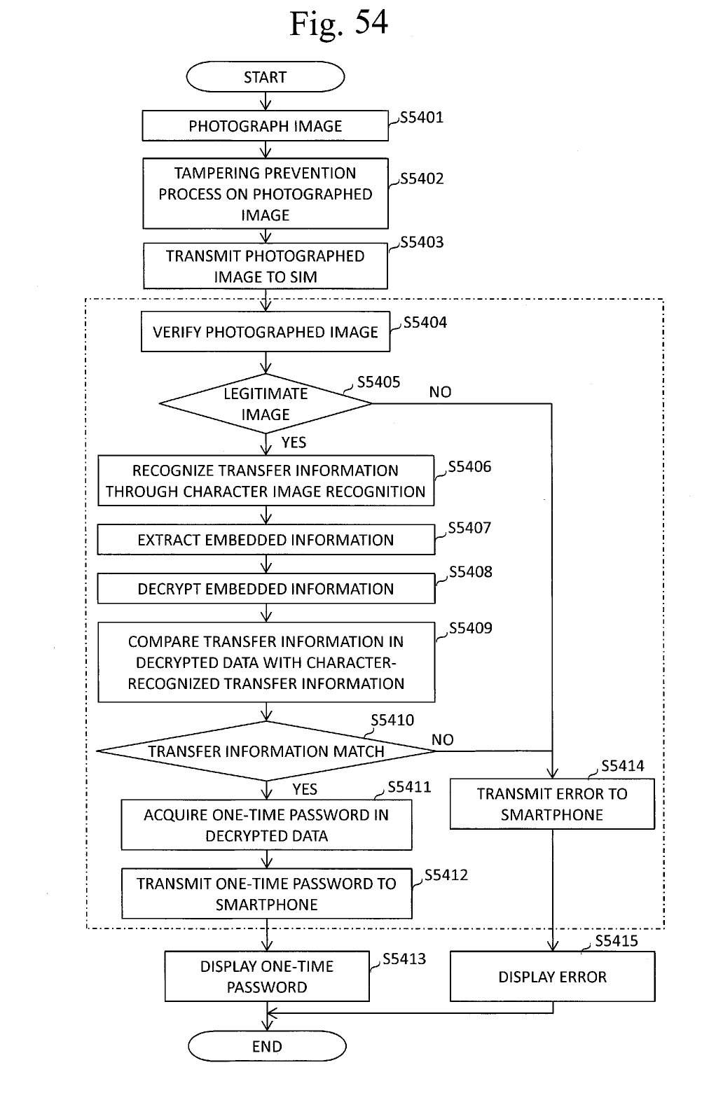

The operation is substantially the same as in Embodiment 10, except for the operation after the smartphone 101 photographs the confirmation screen 3101 (S4401) in FIG. 44 until S4403 in which the transfer information is recognized through character recognition. The operation after the smartphone 101 photographs the confirmation screen 3101 until the transfer information is recognized through character recognition will be described hereinafter with reference to FIG. 54.

FIG. 54 is a flowchart illustrating a flow of the operation of the smartphone 101 and the SIM card 210 according to Embodiment 12.

Referring to FIG. 54, when the smartphone 101 photographs an image with the camera device 1601 (S5401), the photographed image tampering prevention device 2001 of the smartphone 101 performs a tampering prevention process on the photographed image by attaching a signature or by encryption (S5402), and then transmits the photographed image to the SIM card 210 (S5403). The image device verification device 2101 of the SIM card 210 which has received the photographed image verifies the photographed image to determine whether or not it is a legitimate image (S5404, S5405).

If the photographed image is legitimate as a result of determination in S5405, the character image recognition device 4002 recognizes the characters shown in the character image 4601 to acquire the transfer information (a destination account number 4602a to 4602h and a transfer amount 4602i to 4602p) (S5406). The operation of S5407 through S5415 thereafter is the same as in Embodiment 10.

On the other hand, if the photographed image is not legitimate, an error is transmitted to the smartphone 101 (S5414), the error is displayed by the display 208 of the smartphone 101 (S5415), and the processing ends.

As described above, the photographed image tampering prevention device of the smartphone and the photographed image verification device of the SIM card share secret information in advance, and the secret information is used to detect tampering. Thus, even if the smartphone is infected with malware, tampering of a photographed image by the malware can be prevented. Therefore, an online transaction with enhanced security can be realized.

### Embodiment 13

In Embodiments 10 to 12 above, the display device (display) of the user terminal (smartphone) displays transaction information (transfer information and a random number) without performing special processing on the transaction information. This embodiment describes an embodiment in which a display device of a user terminal displays transaction information in accordance with a secret rule set by a user in advance. This embodiment corresponds to a case in which the display method of the user terminal described in Embodiment 2 is applied to Embodiments 10 to 12. This embodiment will be described assuming that the secret rule is that the color of displayed characters changes depending on a transfer amount range. However, the secret rule is not limited to this.

In this embodiment, a hardware configuration of a smartphone 101 which is a user terminal is identical to that of FIG. 16 described in Embodiment 3. A hardware configuration of a host server 103 is identical to that of FIG. 41 described in Embodiment 10. A hardware configuration of a client computer 102 is identical to that of FIG. 5 described in Embodiment 1.

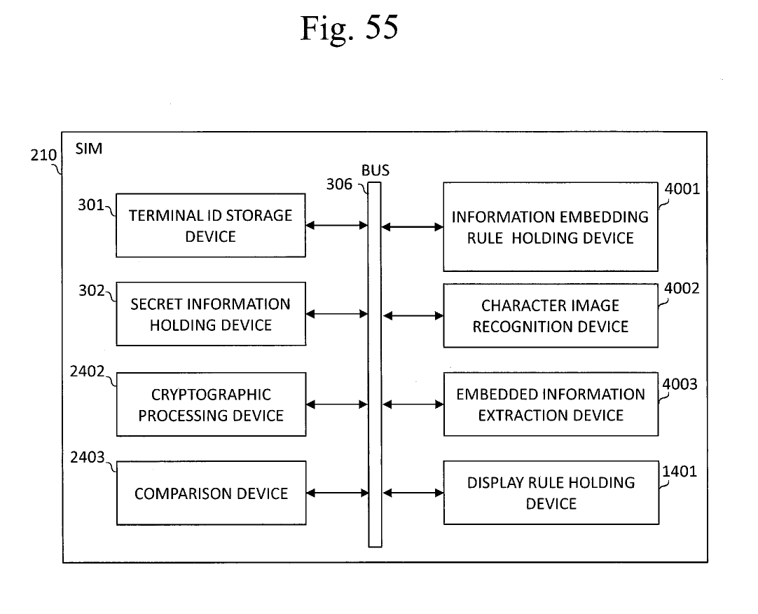

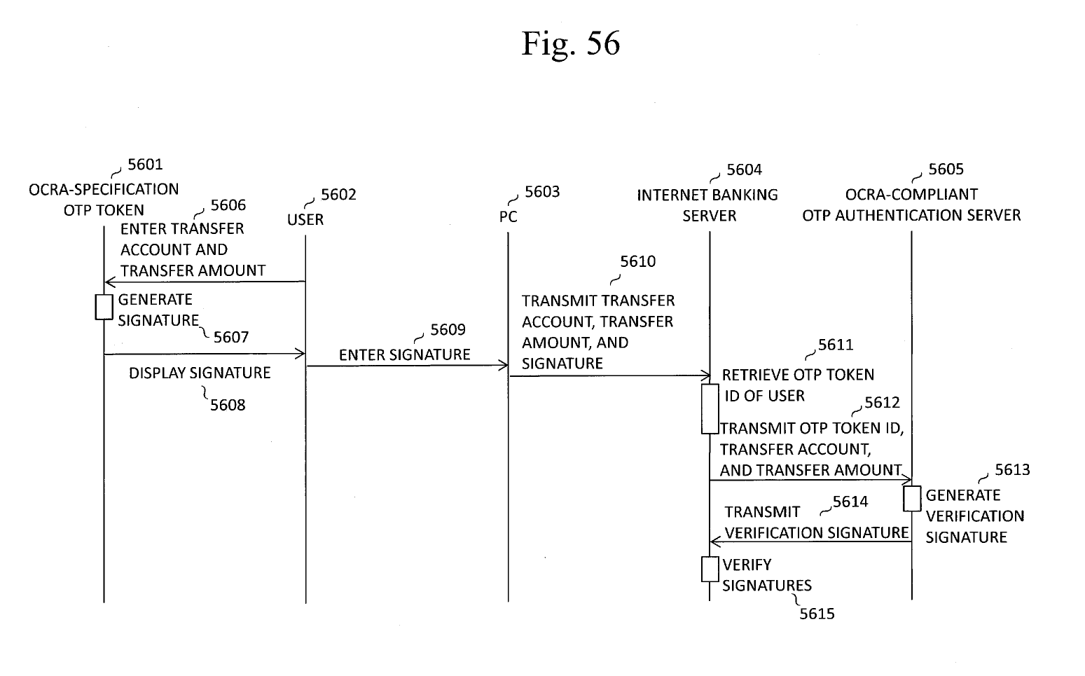

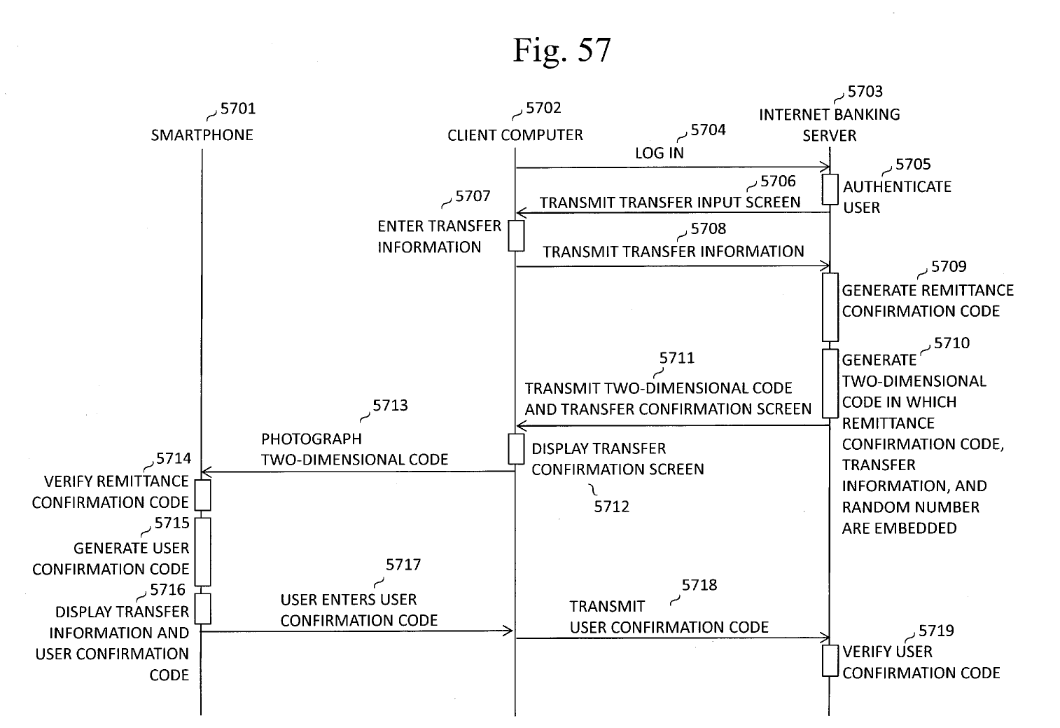

FIG. 55 is a diagram illustrating a hardware configuration of a SIM card 210 according to Embodiment 13.

Referring to FIG. 55, a terminal ID storage device 301 for fulfilling regular functions of the SIM card 210 is connected to a bus 306.

In addition, as in Embodiment 10, a secret information holding device 302 on the user-terminal side, an information embedding rule holding device 4001 on the user-terminal side, a character image recognition device 4002, an embedded information extraction device 4003, a cryptographic processing device 2402 on the user-terminal side, and a comparison device 2403 on the user-terminal side are connected to the bus 306 of the SIM card 210. The secret information holding device 302 on the user-terminal side is a device that holds secret information shared with the host server 103 of a bank in some way in advance. The information embedding rule holding device 4001 on the user-terminal side is a device that holds an information embedding rule 4701 shared with the host server 103 of the bank in some way in advance. The character image recognition device 4002 is a device that recognizes characters represented by a character image included in an image photographed with the camera device 1601 of the smartphone 101. The embedded information extraction device 4003 is a device that extracts embedded information data which is information embedded in the character image photographed with the camera device 1601 of the smartphone 101. The cryptographic processing device 2402 on the user-terminal side is a device that performs an encryption process and a keyed hash operation process, using the secret information held in the secret information holding device 302 on the user-terminal side. The comparison device 2403 on the user-terminal side is a device that compares the transfer information recognized by the character image recognition device 4002 with the transfer information obtained from the embedded information data extracted by the embedded information extraction device 4003, and outputs a comparison result.

A display rule holding device 1401 is also connected to the bus 306 of the SIM card 210. The display rule holding device 1401 is a device that securely holds a display rule which defines a display method for the smartphone 101 when displaying transfer information and a one-time password on the display 208. As in Embodiment 3, the display rule is held by the display rule table 1501 illustrated in FIG. 15, and is set by the user in some way in advance.

The operation of an online transaction according to Embodiment 13 will now be described.

The operation is substantially the same as in Embodiment 10, except for the operation in S4410 of FIG. 44 in which the transfer information and the one-time password of FIG. 32 are displayed by the display 208 of the smartphone 101.

When the display 208 of the smartphone 101 displays the transfer information (a transfer destination account number 1302 and a transfer amount 1303) and a one-time password 3202, the display 208 acquires the display rule table 1501 from the display rule holding device 1401 of the SIM card 210, and changes a character color in accordance with the display rule table 1501. For example, if the transfer amount 1303 is ¥10,000, the display 208 changes the character color to brown in accordance with the display rule table 1501 illustrated in FIG. 15.

As described above, a display rule set by the user in advance is held in the SIM card into which malware cannot intrude, and the smartphone displays transaction information in accordance with the display rule. Thus, it is difficult for malware which has infected the smartphone to change the display without being noticed by the user. Therefore, an online transaction with enhanced security can be realized.

### Embodiment 14

In Embodiments 1 to 13 above, while processing is performed on the user terminal (smartphone) and the SIM card mounted on the user terminal, the communication device (the wireless LAN module and the communication/call module) of the user terminal continues to function and is capable of communication. Thus, it is possible for malware which has infected the user terminal to collaborate with malware which has infected the client computer. This embodiment describes an embodiment in which while processing is performed on a user terminal and a SIM card mounted on the user terminal, the function of a communication device of the user terminal is disabled.

In this embodiment, hardware configurations of a smartphone 101 which is a user terminal, a host server 103, and a client computer 102 are respectively identical to those of the drawings described in Embodiments 1 to 13.

The operation of an online transaction according to Embodiment 14 will now be described.

An operational sequence of the online transaction, a flowchart of the client computer 102, a flowchart of the host server 103, and a flowchart of the smartphone 101 and the SIM card 210 are respectively the same as those of the drawings described in Embodiments 1 to 13.

Note that in this embodiment, when the smartphone 101 and the SIM card 210 start processing related to a transaction such as a transfer, the wireless LAN module 204 and the communication/call module 205 of the smartphone 101 suspend the communication/call function. Further, when the smartphone 101 and the SIM card 210 finish the processing related to the transaction such as the transfer, the wireless LAN module 204 and the communication/call module 205 of the smartphone 101 resume the communication/call function.

As described above, while processing related to an online transaction is being performed, the communication function of the user terminal is disabled. Thus, since this makes it difficult for malware which has infected the user terminal and malware which has infected the client computer to collaborate with each other, it is possible to prevent the malware which has infected the user terminal from performing a malicious action on the SIM card. Therefore, an online transaction with guaranteed enhanced security and credibility can be realized.

### REFERENCE SIGNS LIST

101: smartphone; 102: client computer; 103: host server, 104: Internet; 105: cellular phone network; 201, 401: CPU; 202, 402: memory; 203: flash memory; 204: wireless LAN module; 205: communication/call module; 206: input interface; 207: audio interface; 208: display; 209: microphone; 210: SIM card; 211, 306, 411, 508: bus; 301: terminal ID storage device; 302: secret information holding device on the user-terminal side; 303, 3301: signature generation device on the user-terminal side; 304: voice print authentication device; 305: voice recognition device; 403: HDD; 404: communication module; 405: Web server device; 406: secret information holding device on the server side; 407: random number generation device; 408, 3401: signature generation device on the server side; 409: signature comparison device; 410: transaction device; 1401: display rule holding device; 1601: camera device; 1701: character recognition device; 2001: photographed image tampering prevention device; 2101: photographed image verification device; 2401: two-dimensional code processing device; 2402, 2501: cryptographic processing device; 2403, 2503: comparison device; 2502: two-dimensional code generation device; 4001: information embedding rule holding device; 4002: character image recognition device; 4003: embedded information extraction device; 4101: information embedding rule holding device; 4102: character image generation device

1-19. (canceled)

20. An authentication device comprising:
processing circuitry to:
store secret information;
verify validity of input data including input information of a user;
extract the input information from the input data the validity of which has been verified;
generate authentication information of the user with the extracted input information and the stored secret information; and
display the generated authentication information.

21. The authentication device according to claim 20,
wherein the input information includes user identification information indicating information that can identify the user, and
wherein the processing circuitry verifies the validity of the input data by verifying the user identification information included in the input information in the input data.

22. The authentication device according to claim 21,
wherein the user identification information is voice data which is the input information voiced by the user,
wherein the processing circuitry verifies the validity of the input data by authenticating a voice print of the voice data, and
extracts the input information by performing voice recognition of the voice data.

23. The authentication device according to claim 20, further comprising:
a camera to photograph the input information which is displayed,
wherein the input data is image data obtained by photographing by the camera, and
wherein the processing circuitry extracts the input information by recognizing the image data.

24. The authentication device according to claim 23,
wherein the camera photographs the input information displayed in character form, and
wherein the processing circuitry extracts the input information by performing character recognition of the image data obtained by photographing by the camera.

25. The authentication device according to claim 23,
wherein the camera photographs the input information displayed as a two-dimensional code, and
wherein the processing circuitry extracts the input information by recognizing the two-dimensional code in the image data obtained by photographing by the camera.

26. The authentication device according to claim 23,
wherein the camera photographs the input information displayed in character form and a two-dimensional code generated from the input information, and
wherein the processing circuitry verifies the validity of the input data by extracting first input information by performing character recognition of the image data obtained by photographing by the camera, extracting second input information by recognizing the two-dimensional code photographed by the camera, and comparing the first input information with the second input information.

27. The authentication device according to claim 23,
wherein the processing circuitry generates a first signature from the input information,
wherein the camera photographs the input information displayed in character form and a two-dimensional code generated from a second signature, and
wherein the processing circuitry verifies the validity of the input data by extracting the second signature from the two-dimensional code photographed by the camera, and comparing the first signature with the second signature.

28. The authentication device according to claim 23,
wherein the processing circuitry stores an information embedding rule being a rule that associates a display format of a character image with embedded information which is information to be embedded in the character image,
wherein the camera photographs the input information displayed in character form and a character image representing the input information in a display format, and
wherein the processing circuitry verifies the validity of the input data by performing character recognition of the image data obtained by photographing by the camera to extract first input information, extracting the embedded information associated with the display format of the character image photographed by the camera, as second input information, in accordance with the information embedding rule, and comparing the first input information with the second input information.

29. The authentication device according to claim 23
wherein the processing circuitry stores an information embedding rule being a rule that associates a display format of a character image with embedded information which is information to be embedded in the character image; and
generates a first signature from the input information,
wherein the camera photographs the input information displayed in character form and a character image representing a second signature for the input information in a display format, and
wherein the processing circuitry verifies the validity of the input data by extracting, as the second signature, the embedded information associated with the display format in the character image photographed by the camera, in accordance with the information embedding rule, and comparing the first signature with the second signature.

30. The authentication device according to claim 28,
wherein in the information embedding rule, the display format is a form of a character of the character image, a color of the character, a color of a character frame, a background color of the character, a slope of the character, or a size of the character.

31. The authentication device according to claim 20,
wherein the processing circuitry stores a display rule that defines a method in which the authentication information is displayed, and
displays the authentication information in accordance with the display rule.

32. The authentication device according to claim 20,
wherein the processing circuitry is stored in a SIM card (Subscriber Identity Module card).

33. The authentication device according to claim 23,
wherein the processing circuitry shares the stored secret information and stores the secret information as shared secret information, and encrypt the image data obtained by photographing by the camera with the shared secret information, and
verifies the validity of the input data by decrypting the encrypted image data with the stored secret information.

34. The authentication device according to claim 23,
wherein the processing circuitry shares the stored secret information and stores the secret information as shared secret information, generates a signature with the shared secret information, and attaches the signature to the image data obtained by photographing by the camera, and
verifies the validity of the input data by authenticating the signature attached to the image data with the stored secret information.

35. The authentication device according to claim 20, further comprising:
a communication device to communicate with outside,
wherein while executing a transaction process, the authentication device suspends communication by the communication device to shut off communication with the outside.

36. An authentication system in which a server, a client, and an authentication device communicate to execute a transaction process,
the server comprising:
processing circuitry to:
store secret information shared with the authentication device;
generate a random number with the secret information;
transmit the random number to the client, and receive transaction information and a first signature from the client;
generate a second signature from the secret information, the random number, and the transaction information; and
compare the first signature with the second signature,
the client comprising:
processing circuitry to:
transmit transaction information entered by a user to the server, and receive the random number from the server;
display the transaction information and the random number; and
receive the first signature entered by the user,
the authentication device comprising:
processing circuitry to:
store the secret information shared with the server;
verify validity of input data including input information of the user;
extract the input information from the input data the validity of which has been verified;
generate authentication information of the user with the extracted input information and the stored secret information; and
display the generated authentication information,
wherein the authentication device uses the input information of the user including the transaction information and the displayed random number, as the input data, and uses the displayed authentication information as the first signature, and
wherein the server executes the transaction process if the first signature and the second signature that have been compared match.

37. An authentication system in which a server, a client, and an authentication device communicate to execute a transaction process,
the server comprising:
processing circuitry to:
store secret information shared with the authentication device;
generate a first one-time password;
generate encrypted data by encrypting the first one-time password and transaction information with the secret information;
transmit a confirmation screen including the encrypted data to the client, and receive from the client a second one-time password entered by a user; and
compare the first one-time password with the second one-time password,
the client comprising:
processing circuitry to:
transmit the second one-time password entered by the user to the server, and receive the confirmation screen from the server;
display the confirmation screen; and
receive the second one-time password entered by the user,
the authentication device comprising:
processing circuitry to:
store the secret information shared with the server;
verify validity of input data including input information of the user;
extract the input information from the input data the validity of which has been verified;
generate authentication information of the user with the extracted input information and the stored secret information stored; and
display the generated authentication information,
wherein the authentication device uses the encrypted data and the input data included in the displayed confirmation screen, as the input data, decrypts the encrypted data to acquire the first one-time password and the transaction information, and uses the displayed authentication information, as the first one-time password and the transaction information, and
wherein the server executes the transaction process if the first one-time password and the second one-time password that have been compared match.

38. An authentication method of verifying input data including input information of a user and displaying authentication information of the user, the authentication method comprising:
storing secret information;
verifying validity of the input data;
extracting the input information from the input data the validity of which has been verified;
generating authentication information of the user with the extracted input information and the stored secret information; and
displaying the generated authentication information.
